(19) United States
(12) Patent Application Publication
(10) Pub. No.: US 2026/0276520 A1
(43) Pub. Date: Sep. 17, 2026

(54) PARTICLE CLASSIFICATION AND SORTING SYSTEMS AND METHODS

(71) Applicant: ENGENDER TECHNOLOGIES LIMITED, Auckland (NZ)

(72) Inventors: Fan HONG, Auckland (NZ); Liam Jay BARBER, Auckland (NZ); Peter Anthony Greenwood HOSKING, Auckland (NZ); Simon Andrew ASHFORTH, Auckland (NZ); Matheu BROOM, Auckland (NZ); Timothy John STIRRUP, Auckland (NZ); Gregory George BARKER, Auckland (NZ)

(21) Appl. No.: 19/128,866

(22) PCT Filed: Nov. 13, 2023
(86) PCT No.: PCT/NZ2023/050129

§ 371 Date: May 9, 2025

(30) Foreign Application Priority Data
Nov. 11, 2022 (AU) 2022903396

(51) Int. Cl. G01N 15/1434; G01N 15/01; G01N 15/149

(52) U.S. Cl. CPC G01N 15/1434; G01N 15/01; G01N 15/149

(57) ABSTRACT

In some examples there is provided a method of processing particles in a particle flow. The method comprises delivering a microfluidic stream from a microfluidic aperture into a flow environment, the microfluidic stream comprising a particle flow comprising a plurality of particles; directing interrogating electromagnetic radiation at the particles in the microfluidic steam and monitoring responsive emissions from the irradiated particles; subsequently directing sorting electromagnetic radiation at at least some of the particles in the microfluidic stream in order to sort the particles into at least two populations dependent on the monitored responsive emissions of the particles; the microfluidic stream comprising a continuous phase flow of liquid.

### 1. TECHNICAL FIELD

The present disclosure relates to the classification and sorting of particles such as asymmetric biological cells.

### 2. BACKGROUND

The classification of particles having different characteristics is useful for many subsequent processes. For example, the classification of sperm cells into X and Y populations allows for downstream separation or sorting of these two populations. One category of sperm cells may be more desirable for certain types of animal farming. For example, bovine X sperm cells are preferred for the insemination of cows to produce predominantly female offspring for milking populations.

Challenges exist in the classification and sorting of bovine sperm cells including low sort efficiency and slow sorting speed. Low sort efficiency results in a low percentage of wanted cells (for example X sperm cells) in a collection vessel, compared with the total number of cells introduced into the classification and sorting system. Poor sort efficiency may be caused by a number of factors including poor orientation of cells for classification, inaccurate classification techniques, low efficiency sorting techniques as well as associated processes negatively impacting cell motility. Slow sorting speed extends the time biological cells are outside of optimum storage conditions and can therefore also impact cell motility.

In this specification where reference has been made to patent specifications, other external documents, or other sources of information, this is generally for the purpose of providing a context for discussing the features of the inventions disclosed herein. Unless specifically stated otherwise, reference to such external documents is not to be construed as an admission that such documents, or such sources of information, in any jurisdiction, are prior art, or form part of the common general knowledge in the art.

It is an object of the invention to provide an improved method of classifying and/or sorting particles with distinguishable characteristics, or at least to provide the public with a useful choice of particle classifying and/or sorting methods.

### 3. SUMMARY OF THE INVENTION

In some examples, there is provided a method of processing particles in a particle flow. The method comprises delivering a microfluidic stream from a microfluidic aperture into a flow environment, the microfluidic stream comprising a particle flow comprising a plurality of particles; directing interrogating electromagnetic radiation at the particles in the microfluidic steam and monitoring responsive emissions from the irradiated particles; subsequently directing sorting electromagnetic radiation at at least some of the particles in the microfluidic stream in order to sort the particles into at least two populations dependent on the monitored responsive emissions of the particles; wherein the microfluidic stream comprising a continuous phase flow of liquid.

In an example, the particle flow may be surrounded by a sheath flow.

In an example, the flow environment comprises one or more of the following: a microchannel which optionally comprises a substantially transparent material; a substrate exposed to a fluid environment; a liquid fluid environment; a gaseous fluid environment. The flow environment may comprise a gaseous fluid environment and is at least partially enclosed by a gaseous sheath substantially parallel to the microfluidic stream and moving with respect to the gaseous environment.

In an example, the sorting comprises one or more of the following: directing the subsequent sorting electromagnetic radiation at particles in one of the populations in the microfluidic stream to impart radiation pressure on said particles; directing the sorting subsequent electromagnetic radiation at particles in one of the populations in the microfluidic stream to ablate said particles; directing the sorting subsequent electromagnetic radiation at particles which are biological cells wherein the subsequent sorting electromagnetic radiation is configured to transfer energy to a selected cell below a predetermined ablation threshold commensurate with rupturing the cell membrane and above a predetermined priming threshold commensurate with the cell being unviable following a freezing and thawing process.

In an example the interrogating electromagnetic radiation and the sorting electromagnetic radiation are directed through a common optical objective.

In an example, the interrogating electromagnetic radiation and the sorting electromagnetic radiation are directed through the common optical objective at an angle with respect to each other.

In an example, the angle between the interrogating electromagnetic radiation and the sorting electromagnetic radiation directed through the common optical objective is adjusted in order to define an inter-beam distance between a focal point of the interrogating electromagnetic radiation within the microfluidic steam and a focal point of the sorting electromagnetic radiation within the microfluidic steam.

In an example, the microfluidic stream is delivered from a flow control apparatus having the microfluidic aperture, the flow control apparatus being shaped to define a region above the microfluidic aperture through which the interrogating electromagnetic radiation and/or the sorting electromagnetic radiation are directed. The objective optical component may be positioned at least partially within the region.

In an example, the interrogating electromagnetic radiation propagates as an interrogating beam which intersects the microfluidic stream at an emanation distance from the microfluidic aperture, the emanation distance being between 25 and 1000 μm.

In an example, the emanation distance is less than 400 μm and greater than one of: 25 μm, 50 μm, 100 μm.

In an example, the interrogating electromagnetic radiation and the subsequent sorting electromagnetic radiation propagate as respective interrogating and sorting beams which intersect the microfluidic stream separated by an inter-beam distance comprising one or more of the following: at least 10 μm; between 10 μm and 400 μm.

In an example, the interrogating electromagnetic radiation and/or the sorting electromagnetic radiation is controlled to propagate as a respective beam which is equal to or wider than the microfluidic stream when intersecting the microfluidic stream.

In an example, monitoring responsive emissions from the irradiated particles comprises using outputs from a plurality of sensors arrayed about the microfluidic stream arranged to capture responsive emissions from different directions.

In an example, the output from said sensors are normalised to compensate for differences in one of more of the following properties of the responsive emissions captured from respective sensors: amplitude; phase; propagation delay; refractive effects when crossing from the microfluidic stream into the flow environment.

In an example, the method comprises adjusting the cross-section of the microfluidic aperture.

In an example, a flow speed of the microfluidic stream is 5-20 m/s.

In some examples, there is provided a method of processing particles in a particle flow. The method comprises delivering a microfluidic stream from a microfluidic aperture into a flow environment, the microfluidic stream comprising a particle flow comprising a plurality of particles; directing interrogating electromagnetic radiation through a common optical objective at the particles in the microfluidic steam and monitoring responsive emissions from the irradiated particles; subsequently directing sorting electromagnetic radiation through the common optical objective lens at at least some of the particles in the microfluidic stream in order to sort the particles into at least two populations dependent on the monitored responsive emissions of the particles.

In an example, the particle flow may be surrounded by a sheath flow.

In some examples, the interrogating electromagnetic radiation and the sorting electromagnetic radiation are directed through the common optical objective at an angle with respect to each other.

In some examples, the angle between the interrogating electromagnetic radiation and the sorting electromagnetic radiation directed through the common optical objective is adjusted in order to define an inter-beam distance between a focal point of the interrogating electromagnetic radiation within the microfluidic steam and a focal point of the sorting electromagnetic radiation within the microfluidic steam.

In some examples, the microfluidic stream is delivered from a flow control apparatus having the microfluidic aperture, the flow control apparatus begin shaped to define a region above the microfluidic aperture through which the interrogating electromagnetic radiation and/or the sorting electromagnetic radiation are directed.

In some examples, the objective optical component is positioned at least partially within the region.

In some examples the interrogating electromagnetic radiation propagates as an interrogating beam which intersects the microfluidic stream at an emanation distance from the microfluidic aperture, the emanation distance being between 25 and 1000 μm.

In some examples the emanation distance is less than 400 μm and greater than one of: 25 μm, 50 μm, 100 μm.

In some examples, the interrogating electromagnetic radiation and the subsequent sorting electromagnetic radiation propagate as respective interrogating and sorting beams which intersect the microfluidic stream separated by an inter-beam distance comprising one or more of the following: at least 10 μm; between 10 μm and 400 μm.

In some examples, the interrogating electromagnetic radiation and/or the sorting electromagnetic radiation is controlled to propagate as a sorting beam which is equal to or wider than the microfluidic stream when intersecting the microfluidic stream.

In some examples, monitoring responsive emissions from the irradiated particles comprises using outputs from a plurality of sensors arrayed about the microfluidic stream using a photoarray with detectors arranged to capture responsive emissions from different directions.

In some examples, the output from said sensors are normalised to compensate for differences in one of more of the following properties of the responsive emissions captured from respective sensors: amplitude; phase; propagation delay; refractive effects when crossing from the microfluidic stream into the flow environment.

In some examples, the method comprises adjusting the cross-section of the microfluidic aperture.

In some examples a flow speed of the microfluidic stream is 5-20 m/s.

In some examples the microfluidic stream comprises a continuous phase flow of liquid.

In some examples, the flow environment comprises one or more of the following: a microchannel which optionally comprises a substantially transparent material; a substrate exposed to a fluid environment; a liquid fluid environment; a gaseous fluid environment.

In some examples, the flow environment comprises a gaseous fluid environment and is at least partially enclosed by a gaseous sheath substantially parallel to the microfluidic stream and moving with respect to the gaseous environment.

In some examples the sorting comprises one or more of the following: directing the subsequent sorting electromagnetic radiation at particles in one of the populations in the microfluidic stream to impart radiation pressure on said particles; directing the sorting subsequent electromagnetic radiation at particles in one of the populations in the microfluidic stream to ablate said particles; directing the sorting subsequent electromagnetic radiation at particles which are biological cells wherein the subsequent sorting electromagnetic radiation is configured to transfer energy to a selected cell below a predetermined ablation threshold commensurate with rupturing the cell membrane and above a predetermined priming threshold commensurate with the cell being unviable following a freezing and thawing process.

In some examples, there is provided a method of processing particles in a particle flow. The method comprises delivering a microfluidic stream from a microfluidic aperture into a flow environment, the microfluidic stream comprising a particle flow comprising a plurality of particles; directing an interrogating beam at the particles in the microfluidic steam and monitoring responsive emissions from the irradiated particles; subsequently sorting the particles into at least two populations dependent on the monitored responsive emissions of the particles; wherein an emanation distance between the aperture and the interrogating beam is less than 1000 μm.

In an example, the particle flow may be surrounded by a sheath flow.

In some examples the emanation distance is less than 400 μm.

In some examples the emanation distance is greater than one of: 25 μm; 50 μm; 100 μm. In some examples a flow speed of the microfluidic stream is 5-20 m/s.

In some examples sorting the particles comprises directing sorting electromagnetic radiation at at least some of the particles in the microfluidic stream in order to sort the particles into the at least two populations.

In some examples the sorting comprises one or more of the following: directing the subsequent sorting electromagnetic radiation at particles in one of the populations in the microfluidic stream to impart radiation pressure on said particles; directing the sorting subsequent electromagnetic radiation at particles in one of the populations in the microfluidic stream to ablate said particles; directing the sorting subsequent electromagnetic radiation at particles which are biological cells wherein the subsequent sorting electromagnetic radiation is configured to transfer energy to a selected cell below a predetermined ablation threshold commensurate with rupturing the cell membrane and above a predetermined priming threshold commensurate with the cell being unviable following a freezing and thawing process.

In some examples, the interrogating electromagnetic radiation and the sorting electromagnetic radiation are directed through a common optical objective.

In some examples the interrogating electromagnetic radiation and the sorting electromagnetic radiation are directed through the common optical objective at an angle with respect to each other.

In some examples the angle between the interrogating electromagnetic radiation and the sorting electromagnetic radiation directed through the common optical objective is adjusted in order to define an inter-beam distance between a focal point of the interrogating electromagnetic radiation within the microfluidic steam and a focal point of the sorting electromagnetic radiation within the microfluidic steam.

In some examples the microfluidic stream is delivered from a flow control apparatus having the microfluidic aperture, the flow control apparatus begin shaped to define a region above the microfluidic aperture through which the interrogating electromagnetic radiation and/or the sorting electromagnetic radiation are directed.

In some examples the objective optical component is positioned at least partially within the region.

In some examples the interrogating electromagnetic radiation and the subsequent sorting electromagnetic radiation propagate as respective interrogating and sorting beams which intersect the microfluidic stream separated by an inter-beam distance comprising one or more of the following: at least 10 μm; between 10 μm and 400 μm.

In some examples the interrogating electromagnetic radiation and/or the sorting electromagnetic radiation is controlled to propagate as a sorting beam which is equal to or wider than the microfluidic stream when intersecting the microfluidic stream.

In some examples the microfluidic stream comprises a continuous phase flow of liquid.

In some examples the flow environment comprises one or more of the following: a microchannel which optionally comprises a substantially transparent material; a substrate exposed to a fluid environment; a liquid fluid environment; a gaseous fluid environment.

In some examples the flow environment comprises a gaseous fluid environment and is at least partially enclosed by a gaseous sheath substantially parallel to the microfluidic stream and moving with respect to the gaseous environment.

In some examples monitoring responsive emissions from the irradiated particles comprises using outputs from a plurality of sensors arrayed about the microfluidic stream using a photoarray with detectors arranged to capture responsive emissions from different directions.

In some examples the output from said sensors are normalised to compensate for differences in one of more of the following properties of the responsive emissions captured from respective sensors: amplitude; phase; propagation delay; refractive effects when crossing from the microfluidic stream into the flow environment.

In some examples the method comprises adjusting the cross-section of the microfluidic aperture.

In some examples there are provided corresponding apparatus.

In an example, there is provided a method of processing particles in a particle flow. The method comprises delivering a microfluidic stream from a microfluidic aperture into a flow environment, the microfluidic stream comprising a particle flow and surrounding sheath flow, the particle flow comprising a plurality of particles; directing interrogating electromagnetic radiation at the particles in the microfluidic steam and monitoring responsive emissions from the irradiated particles; sorting the particles into at least two populations dependent on the monitored responsive emissions of the particles; wherein the microfluidic aperture has a cross-section extending in one axis more than in a perpendicular axis.

In an example, the microfluidic stream comprises one or more of the following: a continuous phase flow of liquid; a dispersed flow of liquid drops.

In an example, the flow environment comprises one or more of the following: a microchannel; a substrate exposed to a fluid environment; a liquid fluid environment; a gaseous fluid environment.

In an example, the flow environment comprises a gaseous fluid environment and is at least partially enclosed by a gaseous sheath substantially parallel to the microfluidic stream and moving with respect to the gaseous environment.

In an example, the sorting comprises one or more of the following: directing subsequent sorting electromagnetic radiation at particles in one of the populations in the microfluidic stream to impart radiation pressure on said particles; directing sorting subsequent electromagnetic radiation at particles in one of the populations in the microfluidic stream to ablate said particles; applying an electrostatic force to droplets of the microfluidic stream surrounding particles in one of the populations.

In an example, wherein the interrogating electromagnetic radiation and the subsequent sorting electromagnetic radiation propagate through a common objective.

In an example, the interrogating electromagnetic radiation and the subsequent sorting electromagnetic radiation propagate as respective interrogating and sorting beams which intersect the microfluidic stream separated by an inter-beam distance comprising one or more of the following: at least 10 μm; between 10 μm and 400 μm.

In an example, the sorting electromagnetic radiation is controlled to propagate as a sorting beam which intersects the microfluidic stream to provide an elliptical or circular intensity pattern within the microfluidic stream.

In an example, the sorting beam is wider than the microfluidic stream.

In an example, the interrogating electromagnetic radiation is controlled to propagate as an ultraviolet or infrared interrogating beam.

In an example, the interrogating electromagnetic radiation propagates as an interrogating beam which intersect the microfluidic stream at an emanation distance from the microfluidic aperture, the emanation distance being between 25 and 1000 μm.

In an example, the interrogating electromagnetic radiation is controlled to propagate as an interrogating beam which intersects the microfluidic stream to provide an elliptical or circular intensity pattern within the microfluidic stream.

In an example, the interrogating electromagnetic radiation is controlled to propagate as an ultraviolet or infrared interrogating beam.

In an example, the particle is a biological cell and the subsequent sorting electromagnetic radiation is configured to transfer energy to a selected cell below a predetermined ablation threshold commensurate with rupturing the cell membrane and above a predetermined priming threshold commensurate with the cell being unviable following a freezing and thawing process.

In an example, the microfluidic aperture has a cross-section with one of the following shapes: ellipse; rectangle; parallelogram; trapezoid; polygon; square.

In an example, the ratio of the extension of the cross-section of the microfluidic aperture in the one axis to the extension of the cross-section of the microfluidic aperture in the perpendicular axis is between 1:100 and 2:3.

In an example, the ratio is between 1:50 and 1:10.

In an example, the microfluidic aperture has a cross-section that is adjustable.

In an example, the size and/or shape of the cross section of the microfluidic aperture is adjustable.

In an example, the cross-section is automatically adjusted responsive to a performance metric associated with the microfluidic stream.

In an example, a cleaning mode characterised by a maximum cross-sectional area of the microfluidic aperture and a cleaning flow of liquid through the microfluidic aperture, optionally where the cleaning flow has a flow rate higher than the microfluidic stream.

In an example, the method comprises directing a concentrating electromagnetic radiation at the sheath flow to vaporise part of the microfluidic stream subsequent to direction of the interrogating electromagnetic radiation.

In an example, the concentrating electromagnetic radiation is controlled dependent on the monitored responsive emissions of the particles.

In an example, monitoring responsive emissions from the irradiated particles comprises using outputs from a plurality of sensors arrayed about the microfluidic stream.

In an example, the plurality of sensors are implemented as a photoarray with detectors arranged to capture responsive emissions from different directions.

In an example, the output from a said sensor is adjusted dependent on the location of said sensor.

In an example, the output from said sensors are normalised to compensate for differences in one of more of the following properties of the responsive emissions captured from respective sensors: amplitude; phase; propagation delay; refractive effects when crossing from the microfluidic stream into the flow environment.

In an example, the plurality of sensors are arranged in a plane perpendicular to a longitudinal axis of the microfluidic stream and wherein the plurality of sensors are arranged in an arc about the microfluidic stream or a substantially straight line adjacent the microfluidic stream.

In an example, the outputs from the sensors corresponding to responsive emissions from a particle are integrated to generate a signal used to classify said particle.

In an example, a sheath extends parallel to the microfluidic stream and at least partially enclosing the microfluidic stream and the fluid environment.

In an example, the sheath comprises one or more of the following: a gaseous flow moving relative to the fluid environment and through which the interrogating electromagnetic radiation is directed; a transparent solid material through which the interrogating electromagnetic radiation is directed.

In an example, the microfluidic aperture is defined in a flow control apparatus used to generate the microfluidic stream.

In an example there is provided a method of processing particles in a particle flow which comprises delivering a microfluidic stream from a microfluidic aperture into a flow environment, the microfluidic stream comprising a particle flow and surrounding sheath flow, the particle flow comprising a plurality of particles; directing interrogating electromagnetic radiation at the particles in the microfluidic steam and monitoring responsive emissions from the irradiated particles; sorting the particles into at least two populations dependent on the monitored responsive emissions of the particles; directing a concentrating electromagnetic radiation at the sheath flow to vaporise part of the microfluidic stream subsequent to direction of the interrogating electromagnetic radiation.

In an example, the microfluidic stream comprises one or more of the following: a continuous phase flow of liquid; a dispersed flow of liquid drops.

In an example, the flow environment comprises one or more of the following: a microchannel; a substrate exposed to a fluid environment; a liquid fluid environment; a gaseous fluid environment.

In an example, the flow environment comprises a gaseous fluid environment and is at least partially enclosed by a gaseous sheath substantially parallel to the microfluidic stream and moving with respect to the gaseous environment.

In an example, the sorting comprises one or more of the following: directing subsequent sorting electromagnetic radiation at particles in one of the populations in the microfluidic stream to impart radiation pressure on said particles; directing sorting subsequent electromagnetic radiation at particles in one of the populations in the microfluidic stream to ablate said particles; applying an electrostatic force to droplets of the microfluidic stream surrounding particles in one of the populations.

In an example, the interrogating electromagnetic radiation and the subsequent sorting electromagnetic radiation propagate through a common objective.

In an example, the interrogating electromagnetic radiation and the subsequent sorting electromagnetic radiation propagate as respective interrogating and sorting beams which intersect the microfluidic stream separated by an inter-beam distance comprising one or more of the following: at least 10 μm; between 10 μm and 400 μm.

In an example, the sorting electromagnetic radiation is controlled to propagate as a sorting beam which intersects the microfluidic stream to provide an elliptical or circular intensity pattern within the microfluidic stream.

In an example, the sorting beam is wider than the microfluidic stream.

In an example, the interrogating electromagnetic radiation is controlled to propagate as an ultraviolet or infrared interrogating beam.

In an example, the interrogating electromagnetic radiation propagates as an interrogating beam which intersect the microfluidic stream at an emanation distance from the microfluidic aperture, the emanation distance being between 25 and 1000 μm.

In an example, the interrogating electromagnetic radiation is controlled to propagate as an interrogating beam which intersects the microfluidic stream to provide an elliptical or circular intensity pattern within the microfluidic stream.

In an example, the interrogating electromagnetic radiation is controlled to propagate as an ultraviolet or infrared interrogating beam.

In an example, the particle is a biological cell and the subsequent sorting electromagnetic radiation is configured to transfer energy to a selected cell below a predetermined ablation threshold commensurate with rupturing the cell membrane and above a predetermined priming threshold commensurate with the cell becoming unviable following a freezing and thawing process.

In an example, the microfluidic aperture has a cross-section extending in one axis more than in a perpendicular axis.

In an example, the microfluidic aperture has a cross-section with one of the following shapes: ellipse; rectangle; parallelogram; trapezoid; polygon.

In an example, the ratio of the extension of the cross-section of the microfluidic aperture in the one axis to the extension of the cross-section of the microfluidic aperture in the perpendicular axis is between 1:100 and 2:3.

In an example, the ratio is between 1:50 and 1:10.

In an example, the microfluidic aperture has a cross-section that is adjustable.

In an example, the size and/or shape of the cross section of the microfluidic aperture is adjustable.

In an example, the cross-section is automatically adjusted responsive to a metric associated with the microfluidic stream.

In an example, a cleaning mode is characterised by a maximum cross-sectional area of the microfluidic aperture and a cleaning flow of liquid through the microfluidic aperture, optionally where the cleaning flow has a flow rate higher than the microfluidic stream.

In an example, the concentrating electromagnetic radiation is controlled dependent on the monitored responsive emissions of the particles.

In an example, monitoring responsive emissions from the irradiated particles comprises using outputs from a plurality of sensors arrayed about the microfluidic stream.

In an example, the plurality of sensors are implemented as a photoarray with detectors arranged to capture responsive emissions from different directions.

In an example, the output from a said sensor is adjusted dependent on the location of said sensor.

In an example, the output from said sensors are normalised to compensate for differences in one of more of the following properties of the responsive emissions captured from respective sensors: amplitude; phase; propagation delay; refractive effects when crossing from the microfluidic stream into the flow environment.

In an example, the plurality of sensors are arranged in a plane perpendicular to a longitudinal axis of the microfluidic stream and wherein the plurality of sensors are arranged in an arc about the microfluidic stream or a substantially straight line adjacent the microfluidic stream.

In an example, the outputs from the sensors corresponding to responsive emissions from a particle are integrated to generate a signal used to classify said particle.

In an example, a sheath extending parallel to the microfluidic stream and at least partially enclosing the microfluidic stream and the fluid environment.

In an example, the sheath comprises one or more of the following: a gaseous flow moving relative to the fluid environment and through which the interrogating electromagnetic radiation is directed; a transparent solid material through which the interrogating electromagnetic radiation is directed.

In an example, the microfluidic aperture is defined in a flow control apparatus used to generate the microfluidic stream.

In an example, there is provided method of processing particles in a particle flow and comprising delivering a microfluidic stream from a microfluidic aperture into a flow environment, the microfluidic stream comprising a particle flow and surrounding sheath flow, the particle flow comprising a plurality of particles; directing interrogating electromagnetic radiation at the particles in the microfluidic steam and monitoring responsive emissions from the irradiated particles; sorting the particles into at least two populations dependent on the monitored responsive emissions of the particles; wherein monitoring responsive emissions from the irradiated particles comprises using outputs from a plurality of sensors arrayed about the microfluidic stream.

In an example, the microfluidic stream comprises one or more of the following: a continuous phase flow of liquid; a dispersed flow of liquid drops.

In an example, the flow environment comprises one or more of the following: a microchannel; a substrate exposed to a fluid environment; a liquid fluid environment; a gaseous fluid environment.

In an example, the flow environment comprises a gaseous fluid environment and is at least partially enclosed by a gaseous sheath substantially parallel to the microfluidic stream and moving with respect to the gaseous environment.

In an example, the sorting comprises one or more of the following: directing subsequent sorting electromagnetic radiation at particles in one of the populations in the microfluidic stream to impart radiation pressure on said particles; directing sorting subsequent electromagnetic radiation at particles in one of the populations in the microfluidic stream to ablate said particles; applying an electrostatic force to droplets of the microfluidic stream surrounding particles in one of the populations.

In an example, the interrogating electromagnetic radiation and the subsequent sorting electromagnetic radiation propagate through a common objective.

In an example, the interrogating electromagnetic radiation and the subsequent sorting electromagnetic radiation propagate as respective interrogating and sorting beams which intersect the microfluidic stream separated by an inter-beam distance comprising one or more of the following: at least 10 μm; between 10 μm and 400 μm.

In an example, the sorting electromagnetic radiation is controlled to propagate as a sorting beam which intersects the microfluidic stream to provide an elliptical or circular intensity pattern within the microfluidic stream.

In an example, the sorting beam is wider than the microifluidic stream.

In an example, the interrogating electromagnetic radiation is controlled to propagate as an ultraviolet or infrared interrogating beam.

In an example, the interrogating electromagnetic radiation propagates as an interrogating beam which intersect the microfluidic stream at an emanation distance from the microfluidic aperture, the emanation distance being between 25 and 1000 μm.

In an example, the interrogating electromagnetic radiation is controlled to propagate as an interrogating beam which intersects the microfluidic stream to provide an elliptical or circular intensity pattern within the microfluidic stream.

In an example, the interrogating electromagnetic radiation is controlled to propagate as an ultraviolet or infrared interrogating beam.

In an example, the particle is a biological cell and the subsequent sorting electromagnetic radiation is configured to transfer energy to a selected cell below a predetermined ablation threshold commensurate with rupturing the cell membrane and above a predetermined priming threshold commensurate with the cell becoming unviable following a freezing and thawing process.

In an example, the microfluidic aperture has a cross-section extending in one axis more than in a perpendicular axis.

In an example, the microfluidic aperture has a cross-section with one of the following shapes: ellipse; rectangle; parallelogram; trapezoid; polygon.

In an example, the ratio of the extension of the cross-section of the microfluidic aperture in the one axis to the extension of the cross-section of the microfluidic aperture in the perpendicular axis is between 1:100 and 2:3.

In an example, the ratio is between 1:50 and 1:10.

In an example, the microfluidic aperture has a cross-section that is adjustable.

In an example, the size and/or shape of the cross section of the microfluidic aperture is adjustable.

In an example, the cross-section is automatically adjusted responsive to a metric associated with the microfluidic stream.

In an example, the method comprising a cleaning mode characterised by a maximum cross-sectional area of the microfluidic aperture and a cleaning flow of liquid through the microfluidic aperture, optionally wherein the cleaning flow has a flow rate higher than the microfluidic stream.

In an example, the concentrating electromagnetic radiation is controlled dependent on the monitored responsive emissions of the particles.

In an example, the method comprising directing a concentrating electromagnetic radiation at the sheath flow to vaporise part of the microfluidic stream subsequent to direction of the interrogating electromagnetic radiation.

In an example, the plurality of sensors are implemented as a photoarray with detectors arranged to capture responsive emissions from different directions.

In an example, the output from a said adjusted is scaled dependent on the location of said sensor.

In an example, the output from said sensors are normalised to compensate for differences in one of more of the following properties of the responsive emissions captured from respective sensors: amplitude; phase; propagation delay; refractive effects when crossing from the microfluidic stream into the flow environment.

In an example, the plurality of sensors are arranged in a plane perpendicular to a longitudinal axis of the microfluidic stream and wherein the plurality of sensors are arranged in an arc about the microfluidic stream or a substantially straight line adjacent the microfluidic stream.

In an example, the outputs from the sensors corresponding to responsive emissions from a particle are integrated to generate a signal used to classify said particle.

In an example, a sheath extending parallel to the microfluidic stream and at least partially enclosing the microfluidic stream and the fluid environment.

In an example, the sheath comprises one or more of the following: a gaseous flow moving relative to the fluid environment and through which the interrogating electromagnetic radiation is directed; a transparent solid material through which the interrogating electromagnetic radiation is directed.

In an example, the microfluidic aperture is defined in a flow control apparatus used to generate the microfluidic stream.

In an example, there is provided a method of processing particles in a particle flow. The method comprises delivering a microfluidic stream from a microfluidic aperture into a flow environment, the microfluidic stream comprising a particle flow and surrounding sheath flow, the particle flow comprising a plurality of particles; directing interrogating electromagnetic radiation at the particles in the microfluidic steam and monitoring responsive emissions from the irradiated particles; sorting the particles into at least two populations dependent on the monitored responsive emissions of the particles; generating a sheath comprising a gaseous flow moving relative to the fluid environment and extending substantially parallel to the microfluidic stream and at least partially enclosing the microfluidic stream and the fluid environment.

In an example, the microfluidic stream comprises one or more of the following: a continuous phase flow of liquid; a dispersed flow of liquid drops.

In an example, the flow environment comprises one or more of the following: a microchannel; a substrate exposed to a fluid environment; a liquid fluid environment; a gaseous fluid environment.

In an example, the flow environment comprises a gaseous fluid environment and is at least partially enclosed by a gaseous sheath substantially parallel to the microfluidic stream and moving with respect to the gaseous environment.

In an example, the sorting comprising one or more of the following: directing sorting subsequent electromagnetic radiation at particles in one of the populations in the microfluidic stream to ablate said particles; directing subsequent sorting electromagnetic radiation at particles in one of the populations in the microfluidic stream to impart radiation pressure on said particles; applying an electrostatic force to droplets of the microfluidic stream surrounding particles in one of the populations.

In an example, the interrogating electromagnetic radiation and the subsequent sorting electromagnetic radiation propagate through a common objective.

In an example, the interrogating electromagnetic radiation and the subsequent sorting electromagnetic radiation propagate as respective interrogating and sorting beams which intersect the microfluidic stream separated by an inter-beam distance comprising one or more of the following: at least 10 μm; between 10 μm and 400 μm.

In an example, the sorting electromagnetic radiation is controlled to propagate as a sorting beam which intersects the microfluidic stream to provide an elliptical or circular intensity pattern within the microfluidic stream.

In an example, the sorting beam is wider than the microfluidic stream.

In an example, the interrogating electromagnetic radiation is controlled to propagate as an ultraviolet or infrared interrogating beam.

In an example, the interrogating electromagnetic radiation propagates as an interrogating beam which intersect the microfluidic stream at an emanation distance from the microfluidic aperture, the emanation distance being between 25 and 1000 μm.

In an example, the interrogating electromagnetic radiation is controlled to propagate as an interrogating beam which intersects the microfluidic stream to provide an elliptical or circular intensity pattern within the microfluidic stream.

In an example, the interrogating electromagnetic radiation is controlled to propagate as an ultraviolet or infrared interrogating beam.

In an example, the particle is a biological cell and the subsequent sorting electromagnetic radiation is configured to transfer energy to a selected cell below a predetermined ablating threshold commensurate with rupturing the cell membrane above a predetermined priming threshold commensurate with the cell becoming immotile following a freezing and thawing process.

In an example, the microfluidic aperture has a cross-section extending in one axis more than in a perpendicular axis.

In an example, the microfluidic aperture has a cross-section with one of the following shapes: ellipse; rectangle; parallelogram; trapezoid; polygon.

In an example, the ratio of the extension of the cross-section of the microfluidic aperture in the one axis to the extension of the cross-section of the microfluidic aperture in the perpendicular axis is between 1:100 and 2:3.

In an example, the ratio is between 1:50 and 1:10.

In an example, the microfluidic aperture has a cross-section that is adjustable.

In an example, the size and/or shape of the cross section of the microfluidic aperture is adjustable.

In an example, the cross-section is automatically adjusted responsive to a metric associated with the microfluidic stream.

In an example, a cleaning mode is characterised by a maximum cross-sectional area of the microfluidic aperture and a cleaning flow of liquid through the microfluidic aperture, the cleaning flow having a flow rate higher than the microfluidic stream.

In an example, the concentrating electromagnetic radiation is controlled dependent on the monitored responsive emissions of the particles.

In an example, monitoring responsive emissions from the irradiated particles comprises using outputs from a plurality of sensors arrayed about the microfluidic stream.

In an example, the plurality of sensors are implemented as a photoarray with detectors arranged to capture responsive emissions from different directions.

In an example, the output from a said sensor is adjusted dependent on the location of said sensor.

In an example, the output from said sensors are normalised to compensate for differences in one of more of the following properties of the responsive emissions captured from respective sensors: amplitude; phase; propagation delay; refractive effects when crossing from the microfluidic stream into the flow environment.

In an example, the plurality of sensors are arranged in a plane perpendicular to a longitudinal axis of the microfluidic stream and wherein the plurality of sensors or are arranged in an arc about the microfluidic stream or a substantially straight line adjacent the microfluidic stream.

In an example, the outputs from the sensors corresponding to responsive emissions from a particle are integrated to generate a signal used to classify said particle.

In an example, the method comprising directing a concentrating electromagnetic radiation at the sheath flow to vaporise part of the microfluidic stream subsequent to direction of the interrogating electromagnetic radiation.

In an example, the interrogating electromagnetic radiation is directed through the sheath.

In an example, the microfluidic aperture is defined in a flow control apparatus used to generate the microfluidic stream.

In an example, there is provided an apparatus for processing particles in a particle flow. The apparatus comprises means for delivering a microfluidic stream from a microfluidic aperture into a flow environment, the microfluidic stream comprising a particle flow and surrounding sheath flow, the particle flow comprising a plurality of particles; means for directing interrogating electromagnetic radiation at the particles in the microfluidic steam and monitoring responsive emissions from the irradiated particles; means for sorting the particles into at least two populations dependent on the monitored responsive emissions of the particles; wherein: the microfluidic aperture has a cross-section extending in one axis more than in a perpendicular axis; and/or the means for monitoring responsive emissions from the irradiated particles uses outputs from a sensor arrayed about the microfluidic stream; and/or the apparatus comprises means for directing a concentrating electromagnetic radiation at the sheath flow to vaporise part of the microfluidic stream subsequent to direction of the interrogating electromagnetic radiation; and/or the apparatus comprises means for generating a sheath comprising a gaseous flow moving relative to the fluid environment and extending substantially parallel to the microfluidic stream and at least partially enclosing the microfluidic stream and the fluid environment.

In an example, the microfluidic stream comprises one or more of the following: a continuous phase flow of liquid; a dispersed flow of liquid drops.

In an example, the flow environment comprises one or more of the following: a microchannel; a substrate exposed to a fluid environment; a liquid fluid environment; a gaseous fluid environment.

In an example, the flow environment comprises a gaseous fluid environment and is at least partially enclosed by a gaseous sheath substantially parallel to the microfluidic stream and moving with respect to the gaseous environment.

In an example, the means for sorting comprises one or more of the following: means for directing subsequent sorting electromagnetic radiation at particles in one of the populations in the microfluidic stream to impart radiation pressure on said particles; means for directing sorting subsequent electromagnetic radiation at particles in one of the populations in the microfluidic stream to ablate said particles; means for applying an electrostatic force to droplets of the microfluidic stream surrounding particles in one of the populations.

In an example, the interrogating electromagnetic radiation and the subsequent sorting electromagnetic radiation are arranged to propagate through a common objective.

In an example, the interrogating electromagnetic radiation and the subsequent sorting electromagnetic radiation are arranged to propagate as respective interrogating and sorting beams which intersect the microfluidic stream separated by an inter-beam distance comprising one or more of the following: at least 10 μm; between 10 μm and 400 μm.

In an example, the sorting electromagnetic radiation is arranged to propagate as a sorting beam which intersects the microfluidic stream to provide an elliptical or circular intensity pattern within the microfluidic stream.

In an example, the sorting beam is wider than the microfluidic stream.

In an example, the interrogating electromagnetic radiation is arranged to propagate as an ultraviolet or infrared interrogating beam.

In an example, the interrogating electromagnetic radiation is arranged to propagate as an interrogating beam which intersects the microfluidic stream at an emanation distance from the microfluidic aperture, the emanation distance being between 25 and 1000 μm.

In an example, the interrogating electromagnetic radiation is arranged to propagate as an interrogating beam which intersects the microfluidic stream to provide an elliptical or circular intensity pattern within the microfluidic stream.

In an example, the interrogating electromagnetic radiation is arranged to propagate as an ultraviolet or infrared interrogating beam.

In an example, the particle is a biological cell and the subsequent sorting electromagnetic radiation is configured to transfer energy to a selected cell below a predetermined ablation threshold commensurate with rupturing the cell membrane and above a predetermined priming threshold commensurate with the cell being unviable following a freezing and thawing process.

In an example, the microfluidic aperture has a cross-section with one of the following shapes: ellipse; rectangle; parallelogram; trapezoid; polygon.

In an example, the ratio of the extension of the cross-section of the microfluidic aperture in the one axis to the extension of the cross-section of the microfluidic aperture in the perpendicular axis is between 1:100 and 2:3.

In an example, the ratio is between 1:50 and 1:10.

In an example, the microfluidic aperture has a cross-section that is adjustable.

In an example, the size and/or shape of the cross section of the microfluidic aperture is adjustable.

In an example, the apparatus is configured to automatically adjust the cross-section responsive to a performance metric associated with the microfluidic stream.

In an example, the apparatus is configured to operate in a cleaning mode characterised by a maximum cross-sectional area of the microfluidic aperture and a cleaning flow of liquid through the microfluidic aperture, optionally where the cleaning flow has a flow rate higher than the microfluidic stream.

In an example, the concentrating electromagnetic radiation is controlled dependent on the monitored responsive emissions of the particles.

In an example, the plurality of sensors are implemented as a photoarray with detectors arranged to capture responsive emissions from different directions.

In an example, the output from a said sensor is adjusted dependent on the location of said sensor.

In an example, the output from said sensors are arranged to be normalised to compensate for differences in one of more of the following properties of the responsive emissions captured from respective sensors: amplitude; phase; propagation delay; refractive effects when crossing from the microfluidic stream into the flow environment.

In an example, the plurality of sensors are arranged in a plane perpendicular to a longitudinal axis of the microfluidic stream and wherein the plurality of sensors are arranged in an arc about the microfluidic stream or a substantially straight line adjacent the microfluidic stream.

In an example, the outputs from the sensors corresponding to responsive emissions from a particle are integrated to generate a signal used to classify said particle.

In an example, the apparatus comprising a second sheath extending parallel to the microfluidic stream and at least partially enclosing the microfluidic stream and the fluid environment.

In an example, the second sheath comprises one or more of the following: a gaseous flow moving relative to the fluid environment and through which the interrogating electromagnetic radiation is directed; a transparent solid material through which the interrogating electromagnetic radiation is directed.

In an example, the microfluidic aperture is defined in a flow control apparatus used to generate the microfluidic stream.

Aspects of the inventions may also be said broadly to consist in the parts, elements and features referred to or indicated in the specification of application, individually or collectively, in any or all combinations of two or more of said parts, elements or features, and where specific integers are mentioned herein that have known equivalents in the art to which a said invention relates, such known equivalents are deemed to be incorporated herein as if individually set forth.

### 4. BRIEF DESCRIPTION OF THE DRAWINGS

The invention will now be described by way of example only and with reference to the drawings in which:

FIG. 1 is a schematic diagram of a system for classifying and sorting particles according to some examples;

FIG. 2 is a schematic diagram of part of a system for classifying and sorting particles according to some examples;

FIG. 3 illustrates a longitudinal cross-section of an flow control apparatus for use with a system for classifying and sorting particles and according to some examples;

FIG. 4 illustrates a transverse cross-section of the flow control apparatus of FIG. 3;

FIG. 5 illustrates an aperture of a delivery tube for use with a system for classifying and sorting particles and according to some examples;

FIG. 6 illustrates use of surface tension forces to improve orientation of particles according to examples;

FIG. 7 illustrates an aperture of a delivery tube for use with a system for classifying and sorting particles and according to some examples;

FIG. 8 illustrates an adjustable aperture of a delivery tube for use with a system for classifying and sorting particles and according to some examples;

FIG. 9 illustrates a side view of an adjustable aperture of a delivery tube for use with a system for classifying and sorting particles and according to some examples; and

FIGS. 10a-10c illustrate the intensity distribution of a beam for interrogating or sorting particles according to some examples.

FIG. 11 illustrates a region of intensity for a beam focused on a nominal focal point X according to an example;

FIG. 12 illustrates a region of intensity for a beam focussed off-centre of a microfluidic stream according to an example;

FIG. 13 illustrates inter-beam distance v flow speed according to an example;

FIG. 14 illustrates a sheath comprising a discrete sheath component for an objective lens according to an example;

FIG. 15 illustrates implementation of a vaporisation device according to an example;

FIGS. 16a and 16b illustrate droplet formation adjustment according to some examples; and

FIGS. 17a and 17b illustrate detection apparatus according to some examples.

FIG. 18 illustrates an example of the invention showing a trumpet-shaped aperture.

FIG. 19 illustrates an example showing a tapering microfluidic delivery tube;

FIG. 20a illustrates an example of a flow control apparatus shaped to define a region in an upstream direction from an aperture through which at least part of the interrogation and/or sorting beam are directed and/or in which an objective is at least partially located;

FIG. 20b illustrates an example showing stabilisation of a microfluidic stream issued from an aperture;

FIGS. 21a and 21b illustrate the effect of emanation distance on particle discrimination resolution;

FIGS. 22a-22c illustrate examples showing interrogation and sorting beams propagating at an angle with respect to each other and towards a common objective;

FIG. 23 illustrates an example using an arrangement of optical components to provide angled interrogation and sorting beams; and

FIGS. 24a-24c illustrate examples of beams splitter arrangements to provide angled interrogation and sorting beams.

### 5. DETAILED DESCRIPTION OF THE INVENTION

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The term “about” as used herein means a reasonable amount of deviation of the modified term such that the end result is not significantly changed. For example, when applied to a value, the term should be construed as including a deviation of +/−5% of the value.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The terms “can” and “may” are used interchangeably in the present disclosure, and indicate that the referred to element, component, structure, function, functionality, objective, advantage, operation, step, process, apparatus, system, device, result, or clarification, has the ability to be used, included, or produced, or otherwise stand for the proposition indicated in the statement for which the term is used (or referred to) for a particular example(s).

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one example, to A only (optionally including elements other than B); in another example, to B only (optionally including elements other than A); in yet another example, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one example, to at least one, optionally including more than one, A, with no B present (and optionally including elements other than B); in another example, to at least one, optionally including more than one, B, with no A present (and optionally including elements other than A); in yet another example, to at least one, optionally including more than one, A, and at least one, optionally including more than one, B (and optionally including other elements); etc.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

Whenever a range is given in the specification, for example, a temperature range, a time range, or a composition range, all intermediate ranges and subranges, as well as all individual values included in the ranges given are intended to be included in the disclosure.

The following sets forth specific details, such as particular examples or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAS, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions. Memory may be employed to storing temporary variables, holding and transfer of data between processes, non-volatile configuration settings, standard messaging formats and the like. Any suitable form of volatile memory and non-volatile storage may be employed including Random Access Memory (RAM) implemented as Metal Oxide Semiconductors (MOS) or Integrated Circuits (IC), and storage implemented as hard disk drives and flash memory.

Some or all of the described apparatus or functionality may be instantiated in cloud environments such as Docker, Kubenetes or Spark. This cloud functionality may be instantiated in the network edge, apparatus edge, in the local premises or on a remote server coupled via a network such as 4G or 5G. Alternatively, this functionality may be implemented in dedicated hardware.

The term “confinement” as referred to herein refers to the restriction of the cross-sectional shape and size of a flow of particles in a fluid stream. For example, the diameter of a circular section of the flow may be restricted or the dimensions of the major and minor axes of an elliptical section flow may be restricted which may result in a single narrow trajectory with minimal deviation in any polar axis of particles from a defined central longitudinal axis of the flow.

The term “orientation” of asymmetric particles (including cells) means the predominant angle of a face of a representative sample of said particles with respect to an axis substantially perpendicular to the axis of flow of the particles. Without any features imparting an orienting torque on the particles, it is expected that the orientation of said face will be randomly distributed and facing any angle around 360°. A sample of cells that have had an orienting torque applied via an orienting feature will have a non-random angular orientation that preferentially directs the face of the particle in a particular angle so that a predominant angle can be determined or observed.

“Cells” and “X-cells” are referred to herein as examples of particular types of particles that may be desirable to retain within a microfluidic sorting arrangement. Where the term cell is used herein, it may be substituted with the term “particle” and there is no requirement for the cell/particle to be a living cell. Those of skill in the art will readily appreciate that the mention of X-cells is intended to be indicative of any other cells or particles that have characteristics suitable for interrogation and sorting according to the present invention. In particular, X-cells may be substituted herein for any type of particle or cell, including substantially symmetric and asymmetric cells, neurons, red blood cells, tagged cells, viruses, or microbiota as will be known to those of skill in the art.

The term “microfluidic stream” as referred to herein refers to a flow of liquid having at least one geometrically constrained dimension at which surface forces dominate volumetric forces. In an example this may include a liquid stream having a sub-millimetre diameter or other cross-sectional dimension. In an example the microfluidic stream may be a continuous phase flow of liquid such as an unbroken stream of one or more aqueous solutions. This could be a laminar flow having a particle flow comprising particles and a sheath flow surrounding the particle flow. The microfluidic stream may alternatively or additionally comprise a dispersed flow of liquid drops. The microfluidic stream may be associated with one or more performance metrics such as flow rate, cross-sectional diameter and/or dimensions, distance to droplet formation.

The term “flow environment” as referred to herein refers to an environment in which the microfluidic stream may flow through. An example includes a microchannel which may comprise a material such as glass forming an elongate lumen or pathway through which the microfluidic stream flows. The pathway may be fully encompassed by the material between each end of the pathway; or the pathway may have at least one boundary exposing the microfluidic stream to a fluid environment with the material forming a substrate interfacing with the other boundary(s) of the microfluidic stream. In another example, the flow environment may be a fluid environment or volume which may be substantially static or which itself may be flowing. In this example, the microfluidic stream may not interface with a material substrate but be fully encompassed by the fluid environment. The fluid environment may be a liquid such as an aqueous solution or a gas such as air.

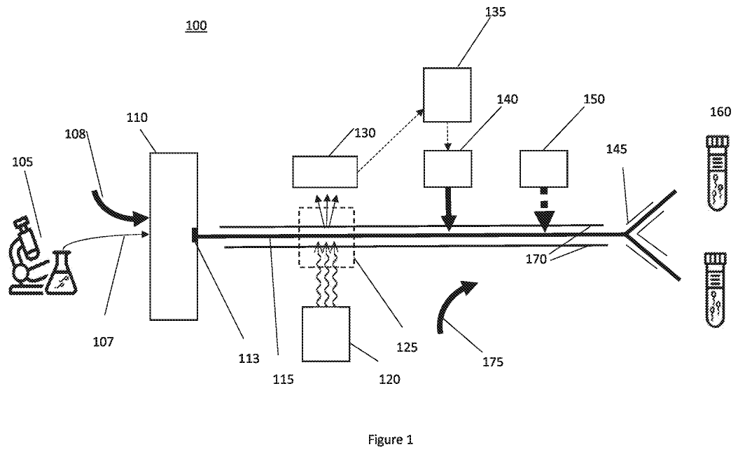

FIG. 1 illustrates a sorting system 100 comprising a preparation station 105 which delivers prepared particles to a flow control apparatus 110 which delivers the particles into a microfluidic stream 115 for downstream processing. The microfluidic stream 115 may be a laminar flow having a predetermined range of cross-sectional dimensions and carried within a flow environment. In an example the flow environment may comprise a volume of gas such as air, or a microchannel fully or partially enclosing the microfluidic channel. One or more illuminators 120 generate an interrogation beam, for example an infra-red (IR) or ultraviolet (UV) illuminator or other irradiation devices. The interrogation beam irradiates the particles within the microfluidic stream at an interrogation area 125. Irradiation of the particles causes them to emit illumination patterns such as scattered or fluorescent light which is detected by one or more detectors 130. Measured characteristics of the detected illumination patterns generate one or more signals which are forwarded to an analysis unit 135.

The analysis unit 135 may comprise a processor and memory and is configured to interpret these signals in order to control a sorting arrangement 140 which processes particles in different populations P1 and P2 depending on analysis of signals associated with those particles. An example analysis unit 135 is described in International Patent publication WO2022139597A1 which is incorporated herein by reference.

If the analysis unit 135 determines that a particle has a particular classification based on analysis of its respective measurement signals, the sorting arrangement 140 is controlled to sort this particle. Various sorting methods may be employed to select this sub-population of particles.

The illuminator 120 directs interrogation electromagnetic radiation to generate an “interrogation beam” and comprises an excitation source adapted to induce emission of a signal or pattern from particles such as cells, for example stained cells. In one example, the illuminator comprises an infra-red (IR) or mid-IR laser 123, more preferably a mid-IR quantum cascade laser (QCL). These lasers have the potential to focus sufficient energy onto a single cell to make an accurate, high-speed measurement. QCLs offer several advantages over traditional mid-IR sources such as delivering very high spectral power density and delivering very high spatial or angular power density. This allows QCLs to put 10,000,000 times more effective mid-IR power onto a single cell than traditional mid-IR sources. QCLs also enable cells to be detected with lower levels of staining, or, in some instances with label-free detection. Dyes or labels can alter or damage cells. Therefore when label-free detection of cells is used, measurements using mid-IR illumination are 25× less energetic than that used in FACS, eliminating photon damage, as well as enabling high-throughput (>10000 cells/second) capability. Mid-IR may include wavelengths of 5-28 microns.

In an alternative example, the illuminator 120 generates a UV laser 123. This may be pulsed, continuous wave or quasi-continuous wave. The illuminator may be an LED, for example a UV LED. In one example the illuminator generates an interrogation beam 123 with wavelength of 300-400 nm with a particular example of 355 nm. In one alternative or additional mode, the beam frequency may be from continuous wave to 100 MHz. In another alternative or additional mode, the beam power is from 1 mW to 1 Watt. Focusing optics are included within the system to achieve focusing and/or spatially shaping of the beam.

The sorting arrangement 140 may include a radiation source (or nudging laser) configured to direct radiation on the particles to effect at least one of a force and torque on each particle so as to induce at least one of displacing and orienting (or nudging) each particle relative to an axis defined by the direction of the fluid flow. In examples, the system also includes at least one of free-space optics, fiber-optics, and other waveguides, configured to direct the radiation from the radiation source onto the microfluidic fluid flow. In examples, the radiation source of the sorting arrangement 140 comprises a laser and can be configured for strobe operation. In examples described herein, this emission or direction of sorting electromagnetic radiation (also referred to herein as “radiation pressure”) from the radiation source is referred to as a “sorting beam”. Some examples may utilise mid-IR beams as described above for use as an illuminator.

Implementation of a sorting arrangement may include a radiation source used to ‘nudge’ particles based on classification (for example P1 or P2) determined by the analyser 135 using the outputs of the detectors 130. In one example, the microfluidic stream is contained within a microchannel and the nudged microparticles then travel until a bifurcation 145 is reached. In some examples, the continuous fluid stream may split into two or more branches corresponding to two or more distinct collection tubes 160. While shown in FIG. 1 as having two collection branches, it can be appreciated that the stream 115 may split into three, four, five, or more distinct collection branches. The number of collection branches may be enabled by the use of particular configurations of the sorting arrangement 140 which may include baffles, vanes and/or bifurcation components 145 arranged within the microfluidic stream 115. This is further appreciated when considering the microchannel as a three-dimensional structure. Moreover, the sorting arrangement 140 may include two or more radiation sources, optionally positioned on opposing sides of the microfluidic stream, and separately controllable. These radiation sources “nudge” particles in multiple directions within the microfluidic stream. In one example, the optionally positioned radiation sources may be a plurality of radiation sources arranged around a circumference of a circular cross section microfluidic channel, the circumferentially arranged radiation sources allowing for precise control of particles in any direction. An example sorting arrangement is described in International Patent Publication WO2020/013903A2 which is incorporated herein by reference.

It will be appreciated by those of skill in the art that alternative methods may be employed within the sorting arrangement to achieve separation of the particles with a desired characteristic. For example, use of electrostatic sorting methods, or microbubble-induced particle sorting will be known to those of skill in the art and are designed to accomplish the same task. Here a microbubble or droplet comprising a nudged particle may move laterally with respect to an axis corresponding to the direction of flow and do not, necessarily, remain entrained within separated fluid streams. While increasing a power of the radiation source or similar alternative modification of the sorting arrangement may increase the initial separation distance between the streams of microparticles, the ability to do so without impacting viability of, for example, cells may be desirable. Therefore, using this method of sorting, careful control of the radiation source is desirable to ensure that selected cells are displaced into a different flow path compared with unselected cells and the selected cells are not rendered immotile or unviable as a result of the radiation. This displacement effect is preferably achieved by applying electromagnetic radiation, for example by way of a laser, to change the direction of cells from a first flow path to a different flow path. The particle flow path containing the selected (P1) or unselected (P2) cells may then be directed to a first collection vessel and the particle flow containing the other sub-population of cells discarded or collected in a second, different collection vessel.

In another example, the sorting arrangement 140 comprises a source of electromagnetic radiation that irradiates the microfluidic stream to achieve ablation or damage of selected particles within it. In this example the emission or direction of sorting electromagnetic radiation from the radiation source which causes ablation is also referred to as a “sorting beam”. This arrangement is particularly useful for removing undesirable cells within a larger population. For example, during the production of cell populations for CAR T-cell therapy there may be certain types of cell that do not exhibit the desired phenotype. Cells in this first population (P1) are destroyed, denatured or rendered immotile by the sorting arrangement. The alternative population that does not exhibit the desired characteristic in the microfluidic stream 115, such as desirable cells that have not been selected by the analysis unit, are left undisturbed (P2). The sorted or processed cells in the microfluidic stream 115 may then be collected in one or more collection vessels 160 for further use. The sorting arrangement 140 thereby provides a population of cells (P2) enriched with a desired characteristic. Where sperm cells are used, this desirable population may comprise motile X cells.

In particular examples, the selected cells are asymmetric cells exhibiting a particularly desirable characteristic, for example sperm cells, red blood cells, or nerve cells. The particular classification of selected cells preferably includes Y-chromosome-bearing sperm cells (which correspond to male sperm) or X-chromosome-bearing sperm cells (which correspond to female sperm).

In some examples a pulsed beam is used for sorting. In other examples a continuous wave beam is used for sorting. The amount of energy transmitted to a focal point can be described in terms of peak fluence in J/cm² calculated by laser pulse energy (joules) per effective focal spot area (cm²). In one example where ablation of a particle/cell is achieved, the peak fluence is between 0.1-100 J/cm². In another example, the sorting laser is adapted to cause the liquid at the focal point to change phase to a gas. In this example, the peak fluence may be between 10-1000 J/cm². Provided the particle/cell is also within the region of the focal spot, a peak fluence of greater than about 0.1 J/cm² may result in ablation of the particle/cell. Ablation may be considered the process of transferring energy to the particle sufficient to permanently inactivate the particle. In the context of biological cells, this may include rendering the cell unviable for its normal function or purpose. For example, sperm cells may be ablated to rapidly induce permanent immotility, or they may be ablated to “prime” them to be incapable of surviving downstream processes such as freezing and thawing. In the former, the ablation may involve rupturing the cell surface membrane which destroys cell integrity. During “priming”, the cell surface membrane remains substantially intact, even though motility may be reduced or cease.

In some examples the numerical aperture of optical components such as the objective used for providing the sorting beam ranges between 0.25-0.7. The wavelength of the sorting beam may range between 300-600 nm with particular examples being 480-580 nm and 300-400 nm In one example the sorting beam wavelength is 532 nm +/−5 nm. Alternatively the sorting beam wavelength may be 355 nm +/−5 nm.

The preparation station 105 may comprise apparatus for staining batches of cells, for example sperm cells collected from a bull. Various other preparatory steps may be undertaken such as diluting a semen sample batch, or adding media components which will be known to those of skill in the art. In an example, the interrogation area 125 may include means for detecting a characteristic of each of a plurality of particles so that the particles may be identified. To this end, a fluorescent dye, such as fluorescein isothiocyanate (FITC), R-phycoerythrin (PE), allophycocyanin (APC), and peridinin-chlorophyll-protein-based dyes, as well as Alexa Fluor dyes and green fluorescent protein (GFP), which may have excitation and emission wavelengths within the UV spectrum (or other region of the electromagnetic spectrum, assuming a light source and a detector are appropriately configured), may be deployed to probe individual particles as the particles pass by the interrogation area 125. As an example, wherein the particles are cells, a viability assay, such as calcein-AM and ethidium homodimer-1, can be used to sort viable cells from non-viable cells. Alternatively, the cells may be stained with Hoechst 33342 which is a fluorophore used routinely to stain DNA in X- and Y-chromosome-bearing mammalian sperm. In these examples, the interrogation area 125 can identify a predominant emission wavelength from a given cell and a sorting arrangement can act to sort the cell within the microfluidic stream accordingly.

In one example, the analysis unit 135 may be integrated with a CPU of a computing device or may be separately integrated with the detectors 130 or the sorting arrangement 140. In examples, the analysis unit may be implemented as special purpose logic circuitry, such as an FPGA or an ASIC. In an example, the sorting arrangement may include a radiation source (or nudging laser) and may be configured to optionally direct radiation on each particle to effect at least one of a force and torque on each particle. The movement of the particle may be at least one of displacing and orienting (or nudging) each particle relative to an axis defined by the direction of the fluid flow along the microfluidic stream. To this end, the sorting arrangement 140 may be configured to direct radiation on a particle when the identity of the particle indicates the particle should be irradiated. For instance, into a separate particle flow stream intended for a different collection branch of a microfluidic stream. In examples, the movement of the particle can be achieved by applying an electrostatic charge, as in FACS (Fluorescence-Activated Cell Sorting), by buoyancy, by magnetic activation, as in magnetic-activated cell sorting, and the like. In examples where the particle is an unwanted cell or particle, the radiation directed on the particle may be calibrated to ablate the particle to damage, kill, or reduce the function of said particle/cell. In such examples it may not be necessary to separate the ablated particles from the unablated particles.

The flow control apparatus 110 accepts a particle flow 107 from the preparation station containing a solution, for example an aqueous solution, of cells from the prepared batch. The flow control apparatus 110 also accepts a sheath flow 108 which may also comprise an aqueous solution. In one example, the flow control apparatus 110 combines the particle flow and sheath flow to generate a controlled laminar flow containing the cells—with the sheath flow extending coaxially around the particle flow forming a microfluidic stream. The flow rate of the particle 107 and sheath flows 108 may be controlled, and the flow control apparatus 110 may contain components arranged to control the particle and sheath flows in order to orientate and/or confine the cells within the laminar flow. As some cells are asymmetrical, orientating them in a preferred plane improves their interaction with downstream apparatus such as the detector 130 and the sorting apparatus 140. Furthermore, confining the cells within a narrow flow path improves the likelihood that the downstream illuminators 120 will be incident upon them as intended.

The flow rate of the particle 107 and sheath 108 flows may be controlled, and the flow control apparatus 110 may contain components arranged to control the particle and sheath flows in order to orientate and/or confine the cells within the laminar flow or microfluidic stream. In particular examples of the present disclosure, sample flow rates of the microfluidic stream range from between about 0.1 μl/min to about 20000 μl/min, between about 10 μl/min to about 5000 μl/min. In other examples the microfluidic stream flow rate is greater than about 100 μl/min, greater than about 500 μl/min, greater than about 1000 μl/min, greater than about 2000 μl/min, greater than about 4000 μl/min, greater than about 5000 μl/min, greater than about 6000 μl/min, greater than about 7000 μl/min, greater than about 8000 μl/min, greater than about 9000 μl/min, greater than about 10000 μl/min, greater than about 11000 μl/min, greater than about 12000 μl/min, greater than about 15000 μl/min, and/or greater than about 20000 μl/min.

In some examples, the flow environment into and through which the microfluidic stream flows is a volume of gas. This may facilitate higher flow rates compared with using a microchannel due to reduced friction with the surface of the microfluidic channel. Higher flow rate reduces the overall classification and sorting time for each particle which in the case of biological cells reduces their degradation before being more optimally stored, such as by freezing. Faster flow rate also increases the overall performance of the system enabling larger and/or more samples to be effectively processed. Reduced surface friction of the microfluidic stream may also improve accuracy of classification and/or sorting, by reducing unwanted internal hydrodynamic forces which may displace particles in an unintended manner.

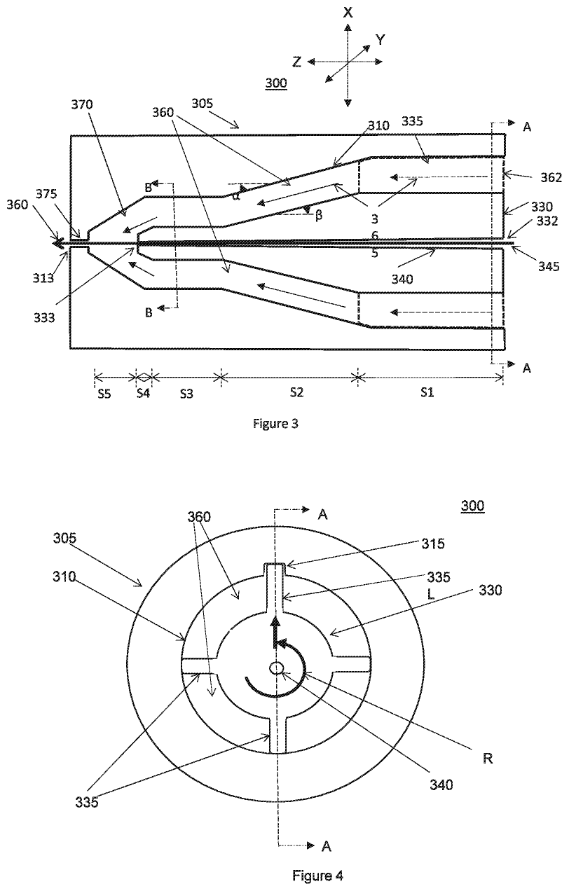

The effectiveness of the flow control apparatus 110 to orient and/or confine the cells may improve the efficiency of the overall sorting system 100. An example of an flow control apparatus for improving cell orientation and/or confinement is a delivery tube as described in International Patent publication WO2020/013903 which is incorporated herein by reference. An example flow control apparatus according to an example is described with respect to FIG. 3. Other arrangements may alternatively be used, for example the flow control apparatus may be part of a cytometer.

The methods and apparatus of some examples of flow control apparatus have utility in achieving orientation of non-spherical particles such as sperm cells. In one example, the angle of the non-spherical particles may be controlled to achieve a desired angle with respect to one or more radiation beams that may be used to interrogate and/or sort the particles. In one particular example the particles are oriented via hydrodynamic and/or radiation-pressure based orientation means. This optimises the interrogation and sorting of particles where the absorption and/or emission of radiation may be highly orientation dependent in asymmetric particles such as sperm cells. Therefore, it may be desirable to orient a preferred facet of an asymmetric particle towards an incoming radiation beam, the facet having a maximum or minimum surface area or some other property.

In an example, the microfluidic stream 115 issues from an aperture 113 of the flow control apparatus 110 into a flow environment. The flow environment may be liquid or gaseous or a combination of these. For liquid and/or gaseous environments in which the microfluidic stream flows, these may be static or include movement. The microfluidic stream may issue in a downwards or gravity-based direction or in a direction at an angle with respect to gravity, for example perpendicular or angled generally upwards. In one example, the flow environment is bounded by a microfluidic channel, microchannel or conduit which allows the microfluidic stream to travel in a controlled way from the aperture and confines the flow of particles as they pass the interrogation area or station 125 and sorting arrangement 140, 143. In some examples, the flow environment may comprise a liquid of substantially the same viscosity as the liquid in the microfluidic stream. In some examples, the flow environment is a liquid of higher viscosity than the microfluidic stream. In some examples the fluid in the flow environment may be moving in the direction of movement of the microfluidic stream. The velocity of this movement may be the same or different from the velocity of the microfluidic stream. In an alternative example, the flow environment comprises a gaseous environment. In the examples of a liquid and/or gaseous flow environment, the microfluidic stream is not required to be bounded by a channel or conduit. This approach has a number of advantages and results in reduced friction with the conduit resulting in improved laminar flow and enabling higher flow rates. The inventors have found that where the aperture engages with a channel or conduit, the aperture size must be aligned with the conduit internal dimensions to ensure that the microfluidic stream maintains laminar flow and have minimal turbulence. Conduit dimensions do not always align with the aperture dimensions which limits the scope of aperture dimensions. By employing a fluid flow environment, this enables flexibility in the size and shape of the aperture. In particular, using a smaller aperture than standardised conduits allows in turn a reduced proportion of sheath flow compared with particle flow. This reduction in sheath volume thereby increases selected cell concentration. The omission of a conduit also reduces refraction of the interrogation beam 123 and if used the sorting beam 143 through the conduit wall resulting in improved accuracy of interrogation and sorting.

In one example, there is provided apparatus and methods for the separation of cells within a microfluidic stream in a gaseous environment. Some examples address effects which arise where interrogation or sorting of particles occurs in a microfluidic stream in a gaseous environment. For example, on entering the cylindrical profile of the microfluidic stream, light or other electromagnetic radiation (EMR) may be refracted due to the refractive index mismatch between, for example, water and air which may then distort the beam. The inventors have also found that there is astigmatism from the cylindrical stream profile which gives two foci, one vertical, one horizontal. This effect causes disruption of beams that enter the stream to interrogate or sort the particles.

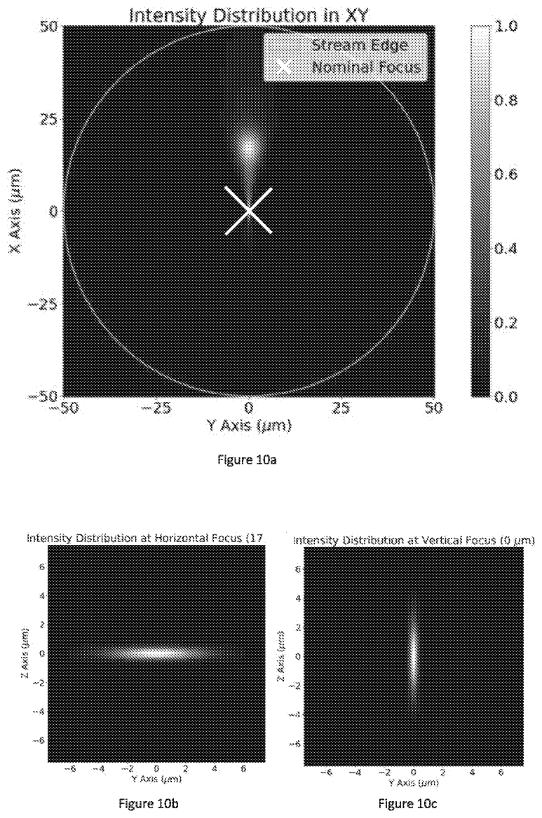

FIG. 10a shows an intensity distribution plot showing the cross section of a microfluidic stream generated using a modelling program, for example using Python/NumPy. The X and Y axes represent the width and length of the cross section of the stream. The nominal focus of the beam is at X=Y=0 in the centre of the circle. It can be observed that there are two foci with the most intense focus (the “horizontal focal point”) being off-set from the centre of the stream. The “vertical focal point” is still focused about the centre of the stream at and around the nominal focal point. The effect of this phenomenon is that targeting of particles flowing in the Z axis (out of the page) is disrupted because the interrogation and/or sorting beams 123, 143 are split and defocused. In addition, the emissions propagated from the particles following interrogation are disrupted causing inefficiencies in particle identification and sorting. FIGS. 10b and 10c show the intensity plot as a cross section through the Z axis and Y axis. FIG. 10b shows a scaled up view of the horizontal focal point and it can be seen that a spot beam is elongated in the Y direction as a result of the mismatch in refractive index. FIG. 10c illustrates how the vertical focal point of the beam (at the nominal focus) undergoes an elongation in the Z axis. This effect is caused by parts of the beam intersecting the surface of the microfluidic stream from a non-perpendicular direction and being refracted to cause the double focus. The actual distance of the centre of the horizontal focal point from the vertical focal point is dependent on the diameter of the stream, the refractive index of the fluid, and the numerical aperture of the objective.

This unusual effect of the beam defocusing and elongating in perpendicular directions when entering the microfluidic stream has led the inventors to develop optical enhancements which enable optimised targeting of the interrogation and/or sorting beams to the particles flowing in the Z axis.

In one example, there is provided a method of applying a radiation beam to a particle flowing in a microfluidic stream, wherein the beam crosses a refractive index boundary prior to entering the microfluidic stream, and wherein the particle flow path is adjusted and/or displaced to be offset from the centre of the flow path. This has the effect of moving the particle into the higher intensity radiation of the horizontal focal point of an incident interrogation or sorting beam. In another example, the invention comprises a method of applying a radiation beam to a particle flowing in a microfluidic stream in a gaseous environment wherein the horizontal focal point is adjusted to be at or about the centre of a circular cross section of a substantially cylindrical microfluidic stream. This has the effect of modifying the focal point and enhancing the radiation pressure which intersects with the particles in the flow. Both examples have the effect of ameliorating or eliminating the effect of the refractive index boundary and therefore increasing the intensity of the laser power intersecting the particles and thus achieving enhanced sorting. In the examples provided above, the radiation applied may be optimised for nudging, interrogation, vapourisation or ablation. The microfluidic stream of the above examples may be within a gaseous environment or within a solid tube or channel or within any other environment which causes a refractive index boundary which refracts the radiation beam.

In some examples, the use of an adjusted beam focus enables the user to minimise the amount of power used to produce the laser and applied to the particles. This may have benefits in minimising heating of optic components and in the microfluidic stream and may reduce the need for displacing particles and/or adjusting the microfluidic stream. Minimising power directed into the stream also minimises collateral damage to other flowing particles, and may enable control over whether cavitation bubbles are formed.

In one example, the interrogation and/or sorting beam is adjusted to form a beam shape with an unequal aspect ratio, for example an elliptical beam shape. This beam shape enables optimisation of the energy applied to the particles while spreading the beam across the flow path of the confined particles in the microfluidic stream. This approach aims to improve beam interaction with particles when desired and to reduce missed beam interaction with particles when desired. Adjusting the beam shape in this way may also provide a more uniform interaction with a higher proportion of particles compared with a spot beam which may have a high intensity in a small area and a very low intensity elsewhere.

In some examples, the beam width of the interrogation beam and/or sorting beam is 1-500 microns. In examples where a more confined flow is achieved, the interrogation and/or sorting beam width is 5-100 microns.

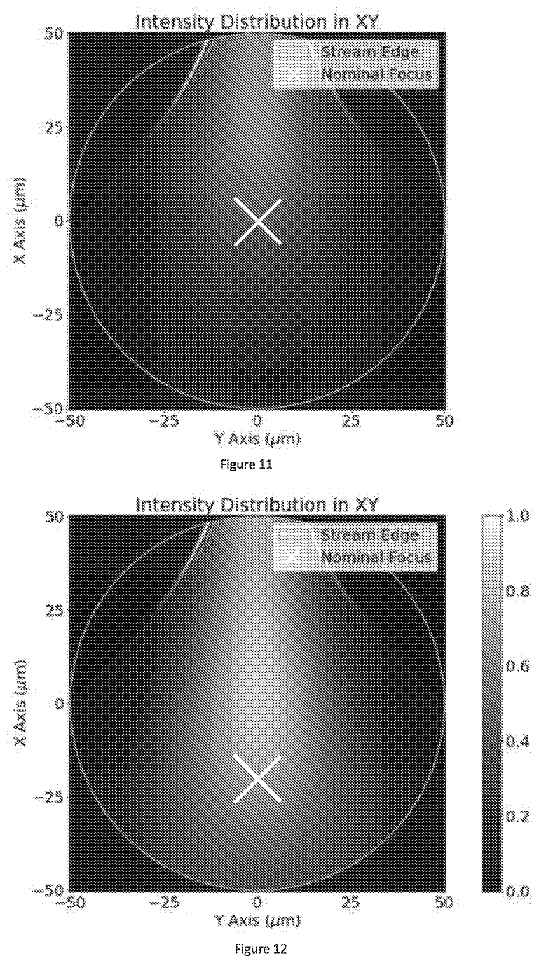

In addition to this dual-foci effect caused by the different refractive index of the flow environment and the microfluidic stream, the inventors have also observed that the focal point of a beam entering the microfluidic stream is misaligned in comparison to a beam entering the stream from a fluid of the same refractive index. FIG. 11 shows the region of intensity when the beam if focused on the nominal focal point X. FIG. 12 shows the region of intensity when the nominal focus is adjusted to be off-centred from the centre of the stream cross-section. It can clearly be observed that the off-centred focus provides a larger region of homogenous intensity within the stream.

When applied to the act of interrogating or sorting a cell within a microfluidic stream, the inventors have found that this lack of beam intensity at the nominal focal point means that cells which should interact with the beam may not. This is especially the case where the confinement of cells is low, i.e. the X or Y-axis spread of cells throughout the stream is high, because the chance that a particular cell falls outside the region of optimal intensity is lower. Therefore, in order to achieve a desired interaction between beam and a large proportion of particles, a higher beam power may be required which may have negative effects on some particles. To address this issue, the inventors have taken the unusual step of intentionally adjusting the focal point to be beyond the nominal focal point—for example moving the focal point “X” as shown in FIGS. 11 and 12. This adjustment has the effect of raising the intensity about the centre of the stream, while also providing an intensity that is more evenly and widely distributed throughout the stream cross-sectional area. Defocussing or diffusing the beam may also or alternatively be used to achieve a similar effect.

In one example that is an alternative or additional feature of a method as previously described, there is provided a method of applying radiation pressure to a particle flowing in a microfluidic stream in a gaseous environment wherein the focal point of said radiation pressure is adjusted to be off centre of a cross section of a substantially cylindrical microfluidic stream. The focal point may be at a point which achieves a maximal area of intensity above a threshold within the stream. The focal point may be adjusted to be offset from the centre of a cross-section of the stream in a direction defined by the beam propagation and in an axis defined by the beam trajectory, wherein the focal point is offset by a distance of between about 10% and 30% of the stream diameter. In some examples the offset distance is between about 15% and 25% of the stream diameter. This technique, referred to herein as “nominal focus offset” has the effect of enhancing the radiation pressure which intersects with the particles in the flow. It also has the effect of increasing the intensity of the laser power intersecting the particles and thus resulting in enhanced interrogation and sorting.

In some examples, an interrogation metric is measured as a result of the interrogation beam interacting with at least one of the microfluidic stream and one or more particles within the stream, the interrogation metric is passed to a control system for processing then an output signal adjusts a flow parameter based on whether the interrogation metric is above or below a certain threshold. In one example the output signal causes a change in one or more of positioning, flow speed, confinement or orientation. In one example the interrogation metric is one or more of fluorescence pulse width, intensity and the ability to discriminate between particle characteristics or populations.

In a further example, the illuminator 120 and/or the sorting arrangement 140 comprises a diffractive optical element (DOE) which diffuses the interrogation beam 123 and/or the sorting beam 143 to achieve a more homogenous intensity across the cross-section of the microfluidic stream. In an example the DOE provides a uniform intensity profile across the distance of the confined particle stream. In one example this DOE projects a substantially “top hat” profile of the respective beam 123, 143 within the microfluidic stream.

In some examples, the focal point and/or profile of the interrogation and/or sorting beam may be dynamically adjusted. This may be dependent on the estimated location of the particle flow within the sheath flow of the microfluidic stream. The particle flow location may be estimated using area-mapped phase shift (AMPS) techniques and the focal point may be set depending on that estimated location. For example, the focal point may be set a predetermined distance beyond the estimated distance of the estimated location. This may be achieved using a mechanical adjustment of an optical component used for providing the interrogation or sorting beams 123, 142. Alternatively, the location of the particle flow may be adjusted to be in a predetermined positional relationship with the focal point. For example, the particle delivery arrangement 110 may be adjusted based on the estimated particle flow location such that this location is adjusted to the desired positional relationship with the focal point(s).

In another example, the focus of the interrogation and/or sorting beam is adjusted to be off-set from the centre of the microfluidic stream. In an example, the off-set is by 15-25% of the diameter of the stream to account for the refraction.

To resolve or at least ameliorate the issues described above relating to refraction and dual focus, the inventors have surprisingly found that placing the illuminator 120 at a specific distance from the fluid stream enables accurate interrogation and sorting. This “working distance” is measured from the emitting side of the final optic component forming the illuminator, to the focal point of the beam within the microfluidic stream. When using a microfluidic stream in a gaseous environment, it is generally desirable to maximise the working distance to reduce the likelihood of droplets contacting the optics through which the interrogation and/or sorting beams propagate, or the detectors at which emissions are detected. In one example the nominal focus offset is achieved by adjusting the position of the lens to account for the defocus and achieve homogenous beam intensity.

In one example, the illuminator emits an interrogation beam and the sorting arrangement emits a sorting beam and both beams propagate through a single objective (optic component). In another example, the interrogation and sorting beams may pass through separate respective optic components as well as at least one shared optic component.

In one example, the working distance is at least 5-50 mm, in some examples the working distance is greater than 10 mm and less than 40 mm. The inventors have calculated that in some examples, the working distance is 10-30% of the stream diameter to achieve optimal offset from the stream.

Where the flow environment comprises a gaseous fluid environment, the gaseous fluid comprises a gas which may comprise one or more gases or gas mixtures selected from the group consisting of air, nitrogen, carbon dioxide, methane or one of the noble gases such as helium, argon, neon, xenon or krypton. In certain examples, the gaseous fluid is an inert gas such as nitrogen or a noble gas. Without wishing to be bound by theory, it is believed that these inert gases reduce oxidation and contamination of the fluid stream which can lead to increased cell viability following downstream processing.

The gaseous fluid environment may be maintained at a fluid temperature and/or a fluid pressure which enhances at least one of cell throughput, detection accuracy, sorting accuracy, or cell health. Cell health in this context means likelihood of survival of the sorting process, motility or viability. In an example, the temperature is between 18 and 37° C. Maintaining the temperature above 20° C. may help to ensure that viscosity is minimised to assist with maintaining the flow and reducing blockages. In alternative examples, the temperature is maintained at less than 15° C. Working below this temperature may minimise the effect of heat stress on the cells and ensure that motility and viability of the cells is maximised after the cells have flowed through the system.

In order to maintain a suitable working distance in accordance with the above-mentioned limitations, while at the same time provide a focal point with appropriate power for interrogation/sorting, the numerical aperture of the sorting and/or interrogation beams may be optimised. The inventors have found that the numerical aperture of the objective lens may be between about 0.1 and 0.7, or in some cases between 0.2 and 0.4.

In an example, when the microfluidic stream exits the aperture into a gaseous environment, the width of the beam is between 30 μm and 200 μm. In certain examples, it may be preferable to maintain a stream width of between 70 μm and 110 μm. The inventors have found that these ranges provide a stream that is wide enough to accommodate the particle flow when it is combined with the sheath flow. These widths also enable accurate sorting via nudging of the particles into a different flow path, or ablation of undesirable particles using an ablation sorting laser.

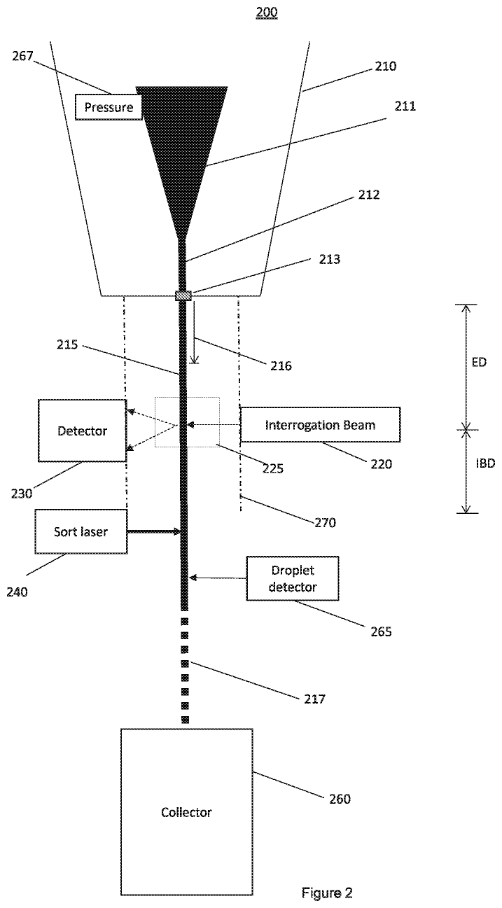

In some examples, the distance from a central point of the aperture 113 in line with a terminal surface of the flow control apparatus to the point at which the interrogation beam contacts the microfluidic stream is 25-1000 μm. This distance is referred to as the “emanation distance”-illustrated as arrow ED in FIG. 2. A shorter emanation distance, for example 50 μm to 500 μm may be preferable so as to retain the confinement of the stream within the flow environment.

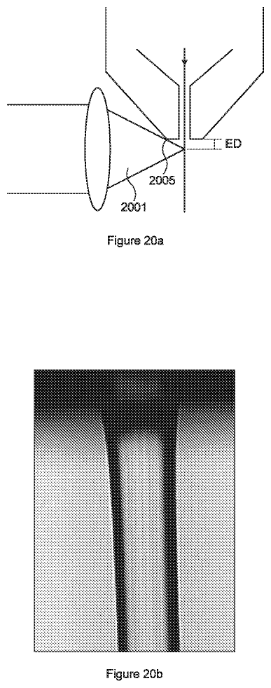

In some examples described herein, steps are taken to adjust the focus or other beam properties to take account of the cylindrical form of the stream. In these instances, this emanation distance should be long enough to allow the stream surface to become smooth. Following emanation from the aperture, the stream tapers and stabilises as shown in FIG. 20b. The inventors have found that attempting interrogation at an emanation distance that is too close to the aperture results in a poor cell emission signal. This is believed to be due to either too little interrogation radiation reaching the cells, or too little emission radiation reaching the detector. This may be due to the refraction of the beam through the non-stabilised stream. In some examples, the interrogation beam comprises a focused beam forming a conical shape 2001 as shown in FIG. 20a. If the emanation distance ED is too small, the cone risks being interrupted by the lower surface of the flow control apparatus 2005 as shown in FIG. 20a. It is also desirable in some examples to provide a distance to allow the stream to stabilise its cross-sectional shape and form into a circular cross-section. These features may assist to enable accurate focussing of the beam onto the particles within the stream, and also to minimise any unpredictable refractive effects when the beam is entering the stream, or emissions are exiting the stream.

The lower surface of the flow control apparatus 2005 may be shaped to define a region above the aperture in the z-direction through which the interrogation beam and/or the sorting beam may be directed. This avoids clipping of parts of the cone of radiation 2001 which improves interrogation performance. Similarly, the objective may at least partially be positioned within this region in order to allow the interrogation beam to focus closer to the aperture. The region shown in FIG. 20a is in the form of a triangular recess extending above the line of the aperture, however other shapes and configurations may alternatively be used for these purposes. This region above the aperture may be defined by an external shape of the flow control apparatus which may include a recess, bevelling or cut-outs from a terminal surface in which the aperture is provided.

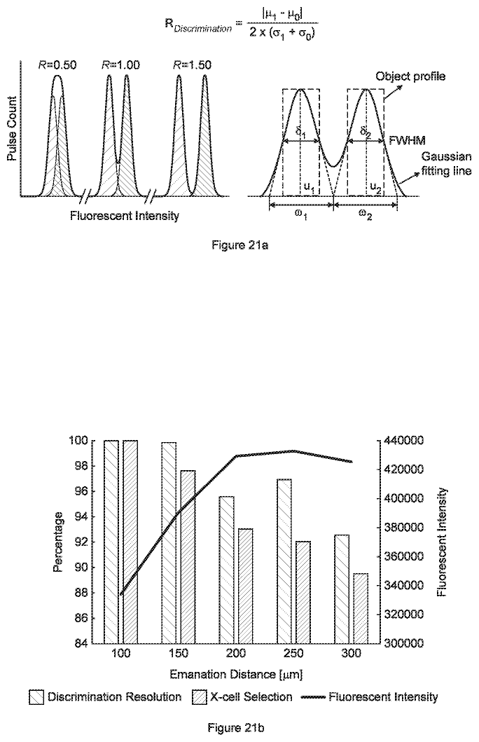

However, as described in more detail below, some examples of the invention make use of the proximity of the interrogation beam contact point to the aperture, i.e. minimising the emanation distance. This can provide benefits in terms of reducing the divergence of the stream and loss of confinement of the sample stream. FIG. 21a shows the results of experiments of varying emanation distance from the aperture to the focal point of the interrogation beam. Discrimination resolution was calculated as shown in FIG. 21a by calculating the separation between two fluorescent emission peaks. Discrimination resolution refers to the ability to discriminate between two cell populations and can be correlated with the amount of overlap between the two peaks, with more overlap corresponding to lower discrimination resolution as cells cannot be distinguished within the overlap. In this example, the peaks correspond to X and Y sperm cells stained with a DNA specific stain. It can be observed that the fluorescence intensity is decreased at lower emanation distance which is understood to be a result of clipping of the beam, or emissions, on the lower surface of the flow focusing apparatus. This results in relatively more overlap between the peaks.

On the other hand, with an emanation distance of 100 μm taken as a baseline (100%) and it can also be observed that at higher emanation distances, the discrimination resolution reduces. Therefore, in an example optimal discrimination resolution can be obtained within a range of emanation distances, not too small and not too large.

The X-cell selection metric also indicates that higher emanation distances cause a reduction in the number of X-cells selected from a combination of X and Y-cells. Where X-cells are desired to be selected and sorted from Y-cells, this effect on X-cell selection will negatively affect the sorting efficiency, throughput and purity of a sorted sample of cells. Accordingly the inventors have determined an optimal interrogation zone with a preferred emanation distance. In one example, the emanation distance is greater than 25 μm, 50 μm or 100 μm. In another example, the emanation distance is lower than 400 μm. In one example, the emanation distance is between 25 μm and 400 μm or between 25 μm and 1000 μm. In another example, the decrease in fluorescence intensity is taken into account and the emanation distance is between 50 μm and 400 μm. In another example, the emanation distance is between 50 μm and 250 μm. Optimal emanation distances may somewhat dependent on flow speed however they may not be significantly affected by this. Accordingly, in one example the flow speed is greater than 5 m/s.

In other embodiments, the flow speed is from 5 m/s to 20 m/s. The interrogation beam and sorting beam are separated by a distance referred to as the “inter-beam distance”-IBD in FIG. 2. In some examples, the inter-beam distance is 15 μm to 1000 μm. Again, it may be desirable to minimise this distance to prevent divergence of the stream in the flow environment, and to minimise the loss of orientation that may be experienced by asymmetric particles moving in the stream. However, the inter-beam distance may be dependent on the time taken to detect the emissions, identify the particle type, process the data to determine how to sort that particular particle, then send a signal to the sorting beam to generate a beam with the appropriate properties to sort the particle. Following extensive experimental analysis and modelling, the inventors have determined the parameters of these events and found the optimal inter-beam distance range for a range of flow speeds. FIG. 13 and table 1 below show the range of inter-beam distances (IBDs) for a particular flow speed, according to an example. In this example, a minimum IBD of 16 μm is achieved at a sample flow speed of 1 ms⁻¹ with a propagation delay of 1.6×10⁻⁵s. With the same propagation delay, a flow speed of 20 ms⁻¹ requires a minimum IBD of 320 μm. Accordingly, in some examples, the IBD is from about 10 μm to about 400 μm. In some examples, the IBD is from about 40 μm to about 300 μm, or about 50 μm to about 200 μm.

TABLE 1
Inter-beam distance v cell flow speed

| Cell velocity | IBD |
|---|---|
| (m/s) | (Microns) |
| 1 | 16 |
| 2 | 32 |
| 3 | 48 |
| 4 | 64 |
| 5 | 80 |
| 6 | 96 |
| 7 | 112 |
| 8 | 128 |
| 9 | 144 |
| 10 | 160 |
| 11 | 176 |
| 12 | 192 |
| 13 | 208 |
| 14 | 224 |
| 15 | 240 |
| 16 | 256 |
| 17 | 272 |
| 18 | 288 |
| 19 | 304 |
| 20 | 320 |

In some examples, the microfluidic stream remains intact and continuous until after it has transited past the interrogation and sorting apparatus beams. The microfluidic stream 115 may remain intact until intercepting one or more collection vessels 160. In alternative examples, the microfluidic stream may become discontinuous and break into droplets at some point after the sorting arrangement 140. In electrostatic flow cytometers known in the art, the microfluidic stream is intentionally disrupted by a charge imparted by an ultrasonic transducer. For example Cossarizza (2017) (see reference 1 details noted below) describes in section 1.4 how a charge is imparted to the stream, then that charge is retained following break-off of droplets at a pre-determined distance from the nozzle orifice/aperture. This distance from the orifice/aperture to the point where the stream becomes discontinuous is termed the “breakoff distance”. In traditional flow cytometry, electrostatically charged plates interact with the charged droplets to bias the droplet flow direction according to cell characteristics identified via the interrogation apparatus. However, vibrations imparted by ultrasonic transducers can disrupt the detection via the interrogation apparatus. Further, if the interrogation apparatus interacts with the fluid stream at a point where droplets have started to form, the uneven and irregular surface of the flow stream results in undesirable and unpredictable refraction of the interrogation beam and emitted illumination patterns. Where the irregularities are predictable, this problem can be ameliorated by using normalisation techniques. However these require computer processing time which in turn slows down the sorting trigger event thus limiting cell throughput and efficiency.

Also, the intentional disruption of the flow is undesirable where the sorting apparatus does not require formation of charged droplets. It has also been hypothesised that imparting a charge to the cells may detrimentally affect their cell surface membrane or cell health. For sperm cells, this has been hypothesised to lead to a reduction in fertility of the sorted sperm cells. To avoid these issues with electrostatic cell sorting, some examples do not comprise an apparatus to induce droplet formation such as an ultrasonic transducer.

In particular examples, the microfluidic stream comprises a continuous stream until after a breakoff distance measured from the aperture. The breakoff distance may be configured depending on the sorting method used in examples and may be implemented by appropriate control of performance metrics of the microfluidic stream such as flow rate and cross-sectional dimensions. In one example, the invention provides an electrostatic arrangement downstream of the sorting arrangement. In this example, the electrostatic arrangement is arranged to attract or repel droplets so that they are collected in a different container to the droplets that are either a) unaffected by the electrostatic sorting, or are attracted in a direction opposite to the desired droplets. This arrangement and process achieves at least one of a) attract droplets with undesirable particles held therein, and b) attract droplets without particles. Both options lead to an increased concentration of desired particles per unit volume by either a) removing undesired particles and the surrounding liquid from a collected desired particle volume, or b) removing liquid from a collected desired particle volume. Increased concentration of desired particles in a collection volume can be beneficial as described below with reference to a vaporisation device 150.

The breakoff distance may be adjusted or maintained by controlling parameters or performance metrics such as the flow rate of the microfluidic stream as well as its cross-sectional dimensions.

In one example, the flow control apparatus 110 comprises one or more features on an internal surface or external surface to extend the breakoff distance. The feature may comprise a hydrodynamic feature adapted to smooth the surface of the microfluidic stream as it exits from the aperture.

In a further example, the sorting apparatus comprises a laser to impart at least one radiation pressure pulse to one or more particles within the fluid stream, wherein said laser is adapted to impart sufficient power to cause: a change in direction of the particle; and/or a droplet to be formed containing said particle. The power required may be determined experimentally.

In this example, a selected particle is irradiated with laser power sufficient to result in a droplet to be formed. The optimal laser power may be determined using experimentation. In some examples two or more laser pulses interact with the stream-one prior to, and one after, a particle in the stream. This causes splitting of the fluid stream both before and after the particle to initiate droplet formation around the particle. As well as creating a droplet, the power imparted to the resulting droplet has the potential to cause a biasing to a different flow path within the flow environment. This enables the selection and separation of the particle from other particles within the microfluidic stream. The use of this approach to encouraging droplet formation may also increase the concentration of particles within drop liquid compared with other methods such as vibration.

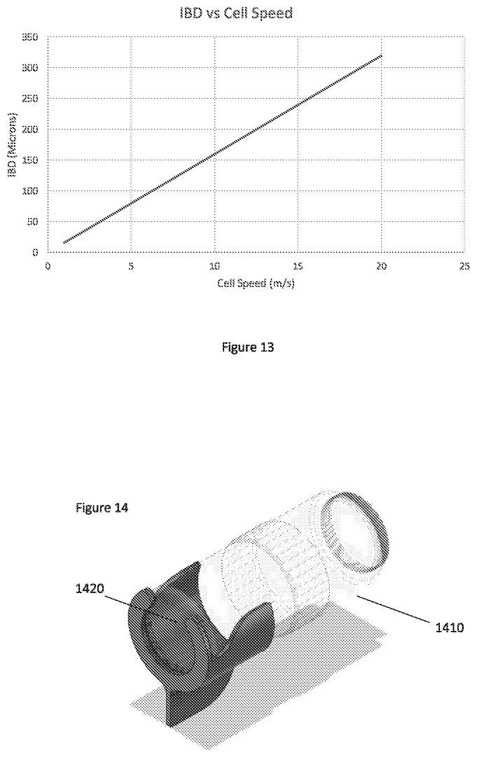

A sheath 170 may partially or fully enclose the microfluidic stream 115 and extends substantially parallel to the microfluidic stream. This sheath protects the microfluidic stream from gaseous flows that may disturb the positioning of the stream as well as contaminants such as dust and dirt particles that may accumulate on auxiliary equipment. Optical components used to provide the interrogation and/or sorting beams may be positioned adjacent to transparent parts of the sheath or may be located in suitably configured orifices or partings in the sheath. In one example, the sheath comprises an air curtain that is applied substantially parallel to the microfluidic stream in a direction substantially aligned with the flow of the microfluidic stream. When observed in a cross-section perpendicular to the longitudinal or Z-axis of flow, the air curtain may be linear (adjacent to the microfluidic stream), semi-circular (partially surrounding the microfluidic stream), or circular (surrounding the microfluidic stream). The air curtain may be applied by way of an annular ring incorporating a plurality of air jets positioned to eject air which shields the microfluidic stream. In one additional or alternative example, the sheath comprises a solid structure made from a suitable impermeable material. The sheath itself may be spaced apart from the surfaces of the microfluidic stream by a gaseous interface and protects the stream from gaseous flows in the wider flow environment. Alternatively, the sheath may fully enclose the microfluidic stream without a gaseous interface between the sheath and the sheath internal wall. Where a gaseous interface exists, the sheath may include orifices or slots to allow some mixing between gas within and outside the sheath, for example to moderate gaseous flows within the sheath. Further, the sheath may protect the stream 115 against contamination from dust and other particulates. In addition, the sheath may prevent the spread of aerosols from the microfluidic steam into the environment surrounding. Such aerosols can collect on sensitive optics which degrades their capacity for accurate sensing. The sheath may also be adapted to cover the optical components which make up at least one of the illuminators 120, detectors 130, and interrogation optics (130 and 120) and/or the sorting arrangement 140. The sheath 170 may extend partially or fully to the collection vessel, optionally also comprising a sheath bifurcation to accommodate separation of the flows. The sheath may take the form of an air curtain, a cylindrical or other shaped tube, a series of flat plates, or any other appropriate arrangement of shielding for the stream. In another example, the sheath comprises discrete components which shield the optics of at least one of the illuminator 120, detectors 130 and/or the sorting apparatus 140. FIG. 14 shows an example of a sheath comprising a discrete sheath component 1410 covering an objective lens 1420. This sheath component 1410 may couple to a larger sheath 170 or the larger sheath may be omitted with one or more sheath components 1410 used to protect beams from various optic components to the microfluidic stream within a gaseous or liquid environment.

In one example, the sheath encloses the microfluidic flow starting from the break-off distance and ending at or about the entrance to a collection vessel. In this example, the sheath does not interfere with the interrogation and optionally sorting beams or detectors.

In another example, the sheath encloses the microfluidic stream starting at or about the aperture and ending at either the break-off distance, or at a point downstream of the sorting laser. In this example the sheath may comprise at least one window or aperture enabling transmission through the window or aperture of the interrogation beam, sorting beam or emissions from the particles.

In some examples the distance from the microfluidic stream to the sheath is from 5 to 20 mm.

The sheath may be arranged to fully or partially enclose the fluid stream.

The inventors have found that where the flow environment is gaseous, the gaseous atmosphere within or around the sheath 170 may be environmentally controlled. This provides advantages including an improvement in cell viability. The environmental control may also be modified so as to cause some evaporation of the outer part (sheath flow) of the microfluidic stream 115. Environmental control may include temperature and humidity control of the gaseous atmosphere, as well as introducing gaseous flows 175 such as a warm airflow at or along the microfluidic stream 115 to further encourage evaporation. The illuminators 120, detectors 130 and sorting arrangement 140 may be arranged for sealed engagement with the sheath 170 to improve the controllability of the atmosphere within the sheath.

In one example, the microfluidic stream may flow within a sheath, conduit or channel which may be circular, square, rectangular, triangular, oval, or another desired shape in cross-section. The sheath, conduit or channel may be formed from any one or more of a polymer, glass, ceramic, or other solid substrate, or may be pre-formed components such as PTFE tubing or glass capillaries. The sheath, conduit or channel may have a depth of between about 10 μm and about 2500 μm, may have a width of between about 50 μm and about 2000 μm, and may have a length of between about 10 μm and about 200 mm. For instance, the depth of the sheath, conduit or channel may be between about 20 μm and about 10 mm, between about 30 μm and about 5000 μm, between about 40 μm and about 1000 μm, between about 50 μm and about 500 μm, between about 60 μm and about 100 μm, and between about 70 μm and about 90 μm. For instance, the width of the sheath, conduit or channel may be between about 50 μm and about 2000 μm, between about 60 μm and about 1500 μm, between about 70 μm and about 1000 μm, between about 80 μm and about 500 μm, and between about 90 μm and about 100 μm. For instance, the length of the sheath, conduit or channel may be between about 10 μm and about 10 mm, between about 100 μm and about 5000 μm, between about 1000 μm and about 2500 μm, and between about 1500 μm and about 2000 μm.

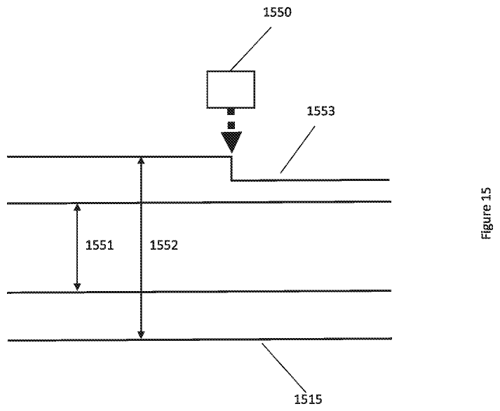

A vaporisation device 150 may be arranged upstream or downstream of the sorting arrangement 140 to direct energy into the microfluidic stream 115 sufficient to evaporate part of the liquid in the stream. The sorting arrangement may additionally or alternatively comprise a vaporisation device. FIG. 15 shows an example of a vaporisation device 1550 emitting directed energy to vaporise part of the stream. The vaporisation device comprises a laser of sufficient power to vaporise a part of the stream. FIG. 15 shows a proportion of the outer layer 1552 of the stream 1515 being vaporised 1553, while the inner particle or “sample” stream 1551 is substantially unaffected. The laser may be timed to vaporise the stream only about no cells or unwanted cells to avoid the additional energy impacting the cell health, motility or viability of the wanted cells in the sample or particle stream 1551. This may be important where radiation energy has already been imparted to the cells to cause a change in direction of the cells into a different flow path.

In another example, the breakoff distance of the microfluidic stream may be controlled such that droplets form after the sorting arrangement 140 with only droplets containing unwanted cells being subject to vaporisation energy by the vaporisation device 150. In this example, the vaporisation device receives signals from the detectors 130 and the analysis unit directs the vaporisation device to implement a timed laser pulse to coincide with the droplet or region of microfluidic stream that is to be vaporised.

Where vaporisation or evaporation of part of the liquid in the stream occurs, a suitable extractor may be provided in the area of the vaporisation to remove the vapour from the gaseous environment. The extractor may be a negative pressure air extractor fan or a solid phase hygroscopic material which absorbs the moisture without causing air movement which may affect collection or sorting.

The abovementioned vaporisation and evaporation examples have the effect of increasing the concentration of wanted cells in the collected media in the collection vessel 160 and this provides a number of advantages. As noted above this may be achieved by reducing the proportion of sheath flow 1552 compared with particle flow 1551, encouraging evaporation along the stream 1515, applying vaporisation energy 1550, or a combination of these.

Concentrated bovine X cells are typically provided in a standardised unit called a “straw” which comprises a standard number of X cells per straw. Therefore increasing concentration of the X cells in the output fluid while maintaining a constant flow rate enables more standardised straws to be produced per hour for example. Where concentration of cells in the output fluid is lower than desirable, a re-concentration process step may be required to reconcentrate said cells. By reducing the concentration as described herein, this can reduce the need for such downstream processing to reconcentrate. One such processing step is centrifugation which may impact on cell health and motility. Processing steps following collection also take time which exposes the sensitive cells to unfavourable temperatures for longer. Centrifugation and other concentrating processes can cause torsion or other mechanical forces which may damage cells. A “companion” effect has also been noted where sperm cells in close proximity to other sperm cells have higher survival rates, motility and fertility. Therefore some examples may provide a solution to the problem of reconcentration affecting sperm by increasing concentration of the cells in the output fluid and therefore avoiding or ameliorating the need to reconcentrate.

In some examples, at least one illuminator, for example an IR or UV illuminator 120 may be oriented to deliver substantially perpendicular irradiation to each cell passing through an interrogation area 125. At least one and preferably two or more detectors 130 may also be oriented so as to absorb emissions from the particles. In one example, two detectors are arranged perpendicular to each other in order to capture responsive fluorescent light emitted from different directions from the irradiated cells. The unique architecture of examples using a fluid stream in a gaseous environment may enable detectors to be positioned perpendicular to one another, whereas planar chip designs only allow detection and interrogation from a single axis (i.e. at the shortest distance through the planar chip). The detectors may be photomultiplier tubes at any appropriate angle to one another, and to the direction of the stream 115. For example for example 90 degrees to each other and the direction of the stream. The detectors may be photomultiplier tubes or other detectors arranged to collect pulses of responsive fluorescent light from the stained particles. In one example, the detector comprises an avalanche photodiode. In one example, the detector is driven by a voltage driver which drives the detector. For example a control voltage may be applied to the detector and a further, tuning voltage to tune the gain of the analog output. An amplifier may optionally be connected to the detector output to amplify and optionally normalise or rectify an output signal. This amplifier is particularly important when detecting emissions from cells due to the very fast flow rates and low emission signals that may be detected from stained and fluorescing cells. The output signal is transmitted to an analysis unit 135 as described above.

In alternative examples where IR lasers are employed without cell staining, the laser, such as a quantum cascade laser (QCL) provides a high spectral power density at specific wavelengths in the mid-IR and THz regime corresponding to molecular bond vibrations. In this instance, the detectors are tuned to detect light transmitted or scattered at different angles.

One additional optical illumination method that may be applied to the previous configurations disclosed herein adds polarization as a sensing modality to the IR-based interrogation of particles in a flow. If molecules being interrogated by mid-IR vibrational spectroscopy are arranged in specific manners within the particle being measured—for example, DNA in helical configuration—the measured absorption at the absorption band of the molecules will depend on the polarization of the mid-IR light. Therefore in one example, the illuminators generate light polarized in a left and right circular polarization and measure the differential. The observed differential, so called vibrational circular dichroism (VCD) may provide a particularly sensitive measurement of chiral or helical molecules, and/or provide information about the folding or configuration of a particular particle/molecule within the analysed particle/cell/droplet. Provided the particles can be successfully differentiated by the detector and analysis apparatus, the sorting apparatus can then act to sort the particles according to these molecular properties. Where two detectors are used, this results in two signals or channels of pulse measurements which are proportional to the intensity or power of the received signal or fluorescent light and which correspond to the particular angle or angles between the detectors directions.

In one example, the interrogation beam and the sorting beam co-propagate through a single or common optical objective such as an objective lens (or lenses) or convex mirror to interact with the particles and the microfluidic stream. The common optical objective is a final optical focussing component closest to the object, in this case the particles in the microfluidic stream. Advantages of this feature of the invention include:
reduction of optical componentry (e.g. objective lenses) around the aperture, interrogation and sorting regions. This can enable better viewing of the stream for alignment and observation purposes and can also facilitate positioning of the interrogation beam close to the aperture in order to reduce emanation distance;
enhanced ease of aligning the beams because multiple lasers will be generally focused on a single focal point;
minimised optical aberration and enhanced ability to focus when focussing through multiple phases e.g. through air, liquid and/or a solid window material.

Sharing optical components reduces complexity of the apparatus and also simplifies setup where the interrogation and sorting beams must be directed to focus on wanted parts of the microfluidic stream—for example the interrogation beam is focussed at a wanted emanation distance and the sorting beam is focussed at an inter-beam distance afterwards. This advantage is enhanced at the small distances involved in operation of example apparatus. Beam positioning may be further simplified by angling the beams relative to each other as they propagate towards the common optical objective. The direction at which the two beams intersect the objective determines where their focii form in the microfluidic stream. As described in more detail below, the inter-beam distance can then be easily configured by adjusting the angle between the beams. The emanation distance may be configured by adjusting the angle at which the interrogation beam intersects the common objective. Alternatively or additionally, the interrogation beam may intersect the common objective at 90 degrees so that it is the position of the objective which sets the emanation distance. The inter-beam distance may then be adjusted by adjusting the angle between the co-propagating interrogation and sorting beams before they intersect the common objective.

The inter-beam distance may be adjusted by modifications to the angle of the beams propagating from the final objective lens. Methods to achieve co-propagation of the interrogation and sorting beams through the same objective include using a dichroic mirror which allows specific wavelengths to pass through, but reflects other wavelengths. Alternatively, if the sorting and interrogation beams are of a similar or identical wavelength, the beams may be polarised and a polarising mirror may be used to reflect the beam of one polarity while allowing the other to pass through.

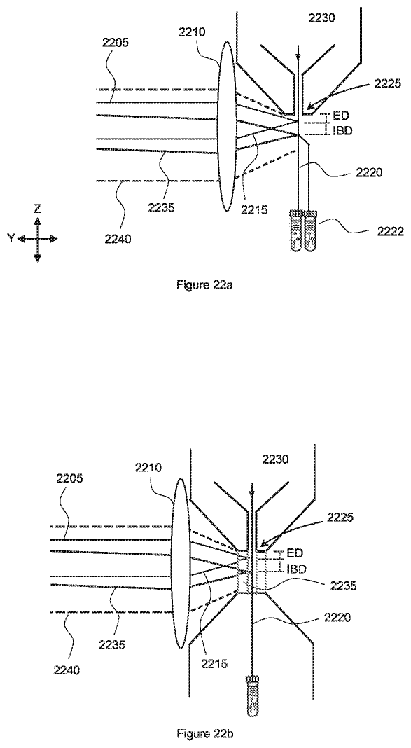

FIG. 22a-c illustrate examples of co-propagating beam arrangements of the invention. In these examples, an interrogation beam 2205 (solid outline) propagates through an optical objective 2210 which focuses 2215 the interrogation beam towards a microfluidic steam 2220 emitted from an aperture 2225 of a flow control apparatus 2230. A co-propagating sorting beam (short-dash line) 2235 co-propagates through the same (common optical) objective and is focused 2215 onto the microfluidic stream 2220 at a downstream position. An emanation distance ED can be observed as being the distance between the lower face of the flow control apparatus and the interaction point of the interrogation beam with the stream. An inter-beam distance IBD can be observed as being the distance between the interaction points of the interrogation beam with the stream and the sorting beam with the stream. An optional third illumination beam is illustrated (long-dash line) 2240 which is broadly focused to illuminate the interrogation/sorting area. The illumination beam provides light to enable imaging of the interrogation/sorting areas.

FIG. 22a illustrates a sorting action in which radiation pressure causes a change in direction of the stream or selected particles within the stream in a gaseous fluid environment. The cells are collected in a first or a second container 2222. The particles are selected according to the characteristics determined following interrogation by the interrogation beam. Although the particles are shown in a gaseous fluid environment, the sorting action may also be carried out in a liquid fluid environment in which the stream is encompassed by a solid microfluidic chip.

FIG. 22b illustrates an apparatus in which the focused beams 2215 pass through a window 2235 and the microfluidic stream is encompassed within a solid microfluidic chip. The semi-focused beams may be adjusted to account for the refractive properties of the window 2235. In examples where a window is used, processes of sorting using this configuration may require a further step of modifying the focal point of at least one of the interrogation and sorting beam to account for any refraction or aberration caused by the window 2235. The illumination beam 2240 also propagates through the window to illuminate the interrogation and sorting areas. When propagating the interrogation beam through a window, optical correction means may be required to reduce distortion.

For example an objective lens comprising a correction collar to prevent distortion. Further, a numerical aperture of less than 0.4 may assist in managing the optical aberrations that arise from using a window. In some examples the window is optically flat to avoid distortion of beam. Further, the window is required to be of a material that is resistant to the beams and any damage that they may cause.

FIG. 22c illustrates an example of the invention in which the microfluidic stream propagates into a gaseous fluid environment. In this example, the interrogation and sorting beams are focused to interact with the stream while the illumination beam 2240 illuminates the area.

As discussed above, an aspect of the present invention is achieving an emanation distance (ED) in a specified range, for example the ranges described above, in conjunction with an optimal inter-beam distance (IBD) in a specified range, for example the ranges described above. The importance of these two distances can be observed in the configurations illustrated in FIGS. 22a-c. The ED is preferably greater than a minimum ED to ensure that the beam does not clip the edge of the flow focusing apparatus. Similarly, maintaining a relatively low IBD enables particles in the stream to stay confined and oriented. These properties degrade with distance from the flow focusing apparatus. Maintaining them increases orientation efficiency and enrichment of the preferred particles selected following interrogation. The IBD is preferably tunable to enable effective discrimination between particles, for example based on emission intensity, flow speed and fluid viscosity.

One option to optimise the IBD is to position the interrogation beam substantially perpendicular to the sorting beam while still being directed at the z-axis of flow. For example one of the interrogation beam and sorting beam would be aligned with the x-axis and the other would be aligned with the y-axis. In this example, the optical componentry does not interfere with each other, and the beams can easily be independently aligned.

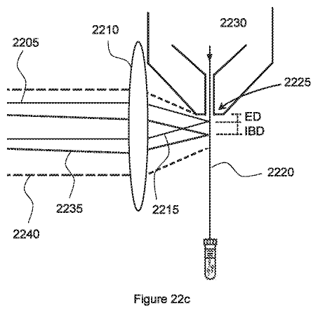

Alternatively, a co-propagating configuration may be used as described above. The co-propagating configuration reduces the amount of optical componentry required but requires a more complex alignment procedure. One example of a co-propagating beam configuration is shown in FIG. 23 in which an interrogation beam 2305 is reflected off a first beam splitter 2310 and defines a first optical path 2315. The optical path optionally passes through a lens 2320 to shape the beam. The interrogation beam is then focused by an objective 2210 to interact with a stream 2220. Alternative examples may comprise the use of a window as shown in FIG. 22b.

A second, sorting beam 2325 propagates towards a second beam splitter 2330 and is reflected to define a second optical path that propagates through the first beam splitter 2310 towards the microfluidic stream 2220. Again, an optional lens may be employed to shape the second beam. It can be observed that the positioning of the second beam at 2325 can be adjusted to achieve a desired IBD. Alternatively, the IBD may be obtained by first aligning the beams in a concentric manner focused on the same position in the stream. At least one of the beams is then angled to create non-parallel beams which result in an inter-beam distance. Accordingly, the sorting and interrogation beams may be angled with respect to one another.

Optionally, a third, illumination beam 2340 may reflect off a third beam splitter 2345 and propagate through the second 2330 and first 2310 beam splitter, and optionally through a lens 2320 to an objective lens 2210 prior to illuminating the interrogation and sorting areas as described above. Alternatively, the third illumination beam 2340 may simply propagate through the second and first beam splitters without a third beam splitter being required. It can be observed that this unique configuration of beams, splitters and lenses synergises with the flow focusing apparatus to achieve stable, fast and accurate cell interrogation, sorting and optionally illumination.

The beam splitters proposed herein comprise coatings that reflect some wavelengths of light, while being substantially transparent to other wavelengths. The beam splitter may be a dichroic beam splitter such as a dichroic mirror, or a harmonic beam splitter. The beam splitter may be a short pass or a long pass splitter. As such, the laser with the higher wavelength of the interrogation laser and sorting laser may be positioned to transmit, as well as reflect in the configurations described herein. In some examples, the beam splitters are polarising mirrors. In one example, the interrogation beam comprises an infra-red (IR) or mid-IR laser, more preferably a mid-IR quantum cascade laser (QCL). In this example, the beam splitter comprises a beam splitter that reflects IR light, for example Thorlabs DMSP805. In another example, the interrogation beam comprises a UV laser in the ultraviolet wavelength range. In one example, the UV laser comprises a wavelength of approximately 355 nm. The first beam splitter in this instance reflects UV light, for example at 355 nm or in the UV range such as Thorlabs DMLP550, DMLP567, DMLP605, DMLP638, DMLP650, DMSP550, DMSP567, DMSP605, DMSP638, DMSP650, HBSY12, HBSY22, HBSY11, HBSY21, FELH0550, FELH0600, FESH0550, FESH0600.

In one example, the wavelength of the interrogation and sorting beams is different. In another example, the wavelength of the interrogation and sorting laser overlaps, for example a 355 nm interrogation laser and 355 nm sorting laser may be used where each beam is polarised in a different plane to the other. In this example, the beam splitters comprise polarising mirrors such as Thorlabs PBS12-355-HP, PBS25-355-HP. In one example, the beam splitter reflects UV light and transmits green light. For example the beam splitter may reflect at around 355 nm and transmit at around 532 nm. In another example, the beam splitter reflects green light and transmits UV light.

In one example, the sorting beam comprises approximately 355 nm, 405 nm, 515 nm, 532 nm, 800 nm, 1030 nm or 1064 nm. The second beam splitter 2330 may comprise a reflect at around 532 nm and transmits at around 1064 nm and/or 660 nm. This enables the illumination beam to pass through for imaging purposes.

In one example, the system comprises an illumination beam at a different wavelength to the sorting and interrogation beams to ensure that there is no interference with detectors or sorting. For example the illumination may be an LED emitting at approximately 565 nm, 590 nm, 595 nm, 617 nm, 625 nm, 660 nm, 680 nm, 700 nm, 730 nm, 780 nm, 810 nm. The system may comprise one or more imaging cameras adjacent a detector.

In one example, the illumination beam illuminates along an axis substantially aligned with the camera optical path entrained on the interrogation and sorting areas. This enables clear and high quality imaging of cells/particles as they are interrogated and optionally sorted. Preferably, the camera is aligned to provide guidance to the alignment of the system and can provide feedback information on beam size, shape, power, and intensity distribution. In one example, the illumination beam comprises a non-overlapping wavelength (colour) to the interrogation and sorting beams to enable filtering during or prior to signal processing.

In one example, the separation of the interrogation beam and the sorting beam to achieve the IBD is achieved by at least one of:
a. The first and/or second beam splitter is angled with respect to the other. This results in the angle of the beams being non-parallel post the beam splitter which achieves a beam separation.
b. The first and/or second beam splitter are parallel, and at least one of the beams is angled with respect to the other beam i.e. they are non-parallel.
c. The objective may be moved and the first beam splitter may be tilted.
d. Positioning of the beams so they are offset onto the beam splitter. In this case the first and second beam splitters may be substantially parallel.

In a further example, at least one of the interrogation and sorting beam pass through a beam expansion optic prior to reaching the beam splitter. Beam expansion (or control over the beam diameter) can be important for optimal compatibility with the optical elements being used (e.g. spreading the power out spatially to mitigate thermal damage). The beam expansion optic may comprise a pin-hole. Pin-holes can be placed at the internal focus and used as a spatial filter to enhance the resolution of the beam profile, for example using a Keplerian style beam expander. The inventors have found that a higher resolution beam profile leads to a more accurate beam profile at the microfluidic stream and therefore more accurate/effective/precise sorting

In some examples, it is preferable to include lens 2320 to shape the beam into an elongated shape for enhanced interrogation and/or sorting. In one example, the lens comprises a cylindrical lens to flatten and elongate the interrogation beam such that it provides a wider focal point. This modification of the beam(s) provides a wider (and thinner in z-axis) focal point is so that the energy of the laser is more uniform across the width of the stream, and each cell experiences less optical intensity variation due to its positional variation. A further key advantage of a thinner focal point is that the cells can be better resolved spatially and temporally in z-axis during interrogation and detection. A cylindrical lens stretches the beam in the x-axis to ensure uniform distribution of laser energy (flux) is across a portion of the microfluidic stream. In one example the laser exhibits a gaussian power distribution across its length. In some examples, at least one of the interrogation and sorting beam are focused to a line. This may be an elliptical gaussian at the focal plane. The inventors have found that a height (z-axis) 1/e² at the focal plane of between about 1-10 μm provides an effective focal point for interrogation or sorting. In some examples, the beam width 1/e² (x-axis perpendicular to flow and beam propagation) of the interrogation or sorting beam may be between about 1-5 times the width of the microfluidic stream. Accordingly, the beam width may be from 150 μm to 750 μm. In one example, the beam width and height for the interrogation and sorting beam differ by less than 20%.

In some examples both the interrogation beam and the sorting beam propagate through the same cylindrical lens. This configuration has advantages in enabling optical components to be positioned close together and the beam profiles to be concentric or overlapping. Further, the lens results in shaping both the interrogation and sorting beams.

In one example, the microfluidic channel through which the stream flows following emission from the aperture may be circular, square, rectangular, triangular, oval, or another desired shape in cross-section. The flow control apparatus comprises both the delivery microchannel and focusing and/or confinement chambers. At least one of the flow control apparatus and the microfluidic channel may be formed from any one or more of a polymer, glass, ceramic, or other solid substrate, or may be pre-formed components such as PTFE tubing or glass capillaries. At least one of the flow control apparatus and the microfluidic may have an internal channel depth of between about 10 μm and about 2500 μm, may have a width of between about 50 μm and about 2000 μm, and may have a length of between about 10 μm and about 20 mm. For instance, the depth of the microfluidic channel may be between about 20 μm and about 10 mm, between about 30 μm and about 5000 μm, between about 40 μm and about 1000 μm, between about 50 μm and about 500 μm, between about 60 μm and about 100 μm, and between about 70 μm and about 90 μm. For instance, the width of the microfluidic channel may be between about 50 μm and about 2000 μm, between about 60 μm and about 1500 μm, between about 70 μm and about 1000 μm, between about 80 μm and about 500 μm, and between about 90 μm and about 100 μm. For instance, the length of the microfluidic channel 402 may be between about 10 μm and about 10 mm, between about 100 μm and about 5000 μm, between about 1000 μm and about 2500 μm, and between about 1500 μm and about 2000 μm.

In some examples, a variety of materials and methods can be used to form any of the above-described components of the present disclosure. In some cases, the various materials selected lend themselves to various methods. For example, the microfluidic focusing apparatus or channel, sheath, window, objectives, supporting brackets or various components of the present disclosure can be formed from solid materials, in which the channels can be formed via micromachining, film deposition processes such as spin coating and chemical vapor deposition, laser fabrication, photolithographic techniques, etching methods including wet chemical or plasma processes, and the like. In one example, at least a portion of the microfluidic channel or flow control apparatus is formed of silicon by etching features in a silicon chip. Technologies for precise and efficient fabrication of various fluidic systems and devices of the present disclosure from silicon are known. In another example, various components of the systems and devices of the present disclosure can be formed of a polymer, for example, an elastomeric polymer such as polydimethylsiloxane (PDMS), polytetrafluoroethylene (PTFE), or the like. In another example, the channels of the present disclosure can be formed from a polymer, glass, ceramic or other solid substrate, or may be pre-formed components such as PTFE tubing or glass capillaries.

Different components can be fabricated of different materials. For example, at least one of the flow control apparatus and the microfluidic channel can be fabricated from an opaque material such as silicon and the window 2235 can be fabricated from a transparent or at least partially transparent material, such as glass or a transparent polymer, for observation and/or control of the interrogation and sorting process. Optionally, the bottom, top or side walls may be formed from optically clear materials to enable efficient transmission of electromagnetic radiation. Components can be coated so as to expose a desired chemical functionality to fluids that contact interior channel walls. For example, components can be fabricated with interior channel walls coated with another material. Material used to fabricate various components of the systems and devices of the present disclosure (e.g., materials used to coat interior walls of fluid channels) may desirably be selected from among those materials that will not adversely affect or be affected by fluid flowing through the fluidic system (e.g., material(s) that are chemically inert in the presence of fluids to be used within the device). In one embodiment, various components of the present disclosure are fabricated from polymeric and/or flexible and/or elastomeric materials, and can be conveniently formed of a hardenable fluid, facilitating fabrication via moulding (e.g., replica moulding, injection moulding, cast moulding, etc.). The hardenable fluid can be essentially any fluid that can be induced to solidify, or that spontaneously solidifies, into a solid capable of containing and/or transporting fluids contemplated for use in and with the described microfluidic system. In one embodiment, the hardenable fluid comprises a polymeric liquid or a liquid polymeric precursor (i.e. a “prepolymer”). Suitable polymeric liquids can include, for example, thermoplastic polymers, thermoset polymers, or a mixture of such polymers heated above their melting point. As another example, a suitable polymeric liquid may include a solution of one or more polymers in a suitable solvent, which solution forms a solid polymeric material upon removal of the solvent, for example, by evaporation. Such polymeric materials, which can be solidified from, for example, a melt state or by solvent evaporation, are well known to those of ordinary skill in the art. A non-limiting list of examples of such polymers includes polymers of the general classes of silicone polymers, epoxy polymers, and acrylate polymers. Silicone polymers including PDMS have several beneficial properties simplifying fabrication of the microfluidic structures of the present disclosure. For instance, such materials are inexpensive, readily available, and can be solidified from a prepolymeric liquid via curing with heat. For example, PDMSs are typically curable by exposure of the prepolymeric liquid to temperatures of about, for example, about 65° C. to about 75° C. for exposure times of, for example, about an hour. Also, silicone polymers, such as PDMS, can be elastomeric and thus may be useful for forming very small features with relatively high aspect ratios, necessary in certain embodiments of the present disclosure. Flexible (e.g., elastomeric) moulds or masters can be advantageous in this regard. In further examples, the components of the present invention may be formed from recycled polymers or biodegradable polymers such as polylactic acid (PLA) and polyhydroxyalkanoates (PHAs).

The measurement of fluorescent light from a cell may be affected by a number of factors including the orientation and confinement of the cell within the interrogation area 125, the level of retained staining of the cell at the interrogation area 125, as well as biological factors such as whether the cell is dead or abnormal. For sperm cells the measurement of fluorescent light also depends on the identity of the sperm sex chromosome (X or Y). The difference in measurement signal due to the presence of the X or Y chromosome is approximately only 3%. This combination of factors make accurate and efficient classification of sperm cells challenging. The signals from the detectors may each correspond to a rapid “strike” applied to each cell to cause the detected signal. A pulse integral signal may be derived for each cell by integrating the individual responsive fluorescent emission pulses associated with an individual cell over a predetermined period. These pulse integral signals for each channel may be generated at the detector apparatus 130 or at the analysis unit 135.

In one example a measurement from a channel corresponding to the fluorescent intensity of the cell represents a measurement datapoint. In some examples, two or more measurements from two or more channels are combined to represent a measurement datapoint. This may include for example a pulse integral of measurements taken from substantially perpendicular directions. A plot of channel 1 (eg 0 degrees) and channel 2 (eg 90 degrees) measurement datapoints is shown in FIG. 2. In further examples, the detectors may be positioned to detect the emissions at other angles to each other, while being substantially perpendicular to the axis of flow. Each datapoint represents a fluorescent pulse integral level measured in at least one, and in some examples two or more perpendicular directions.

The analysis unit 135 of FIG. 1 analyses these signals or measurement datapoints to determine whether a cell should be classified as having a first characteristic A (for example part of the X or Y population) (e.g. P1 or P2), and if so, controls the sorting arrangement 140 to sort the cell. In some examples sorting may be implemented by applying radiation pressure to change the direction of the cell to collect the cell or direct it to waste. This may be implemented by applying radiation pressure using a nudging laser to nudge Y cells into a different part of the stream and thereafter to separate the two flow paths, for example using microfluidic channels. Improving the proportion of cells correctly classified as having a preferred characteristic (e.g. X-bearing sperm cells) improves the efficiency of the sorting apparatus. Other sorting methods may alternatively be used, for example, an ablation laser may apply a directed energy pulse to the cell. This allows all other cells, with a desirable characteristic B (e.g. X chromosome) or unclassifiable, to remain undisturbed by the sorting arrangement 140. In an alternative example, the Y-type sperm cells may be sorted by moving the cell into a different flow path.

In some examples, the sorting arrangement 140 comprises an ablating laser which applies a pulse of laser energy—a “sorting beam”—to the stream 115 as an unwanted cell passes by. This method of sorting overcomes or at least ameliorates some of the disadvantages of more traditional sorting techniques such as charged droplets and charged deflection plates. These traditional methods require a stream charging wire to intersect with the microfluidic stream, typically upstream of an aperture and interrogation beam. The intersection of the wire with the stream can cause disruption and turbulence in the flow which can reduce confinement and orientation, thus leading to compromised sorting efficiency. In one example, the present invention does not comprise a stream charging wire and does not comprise a droplet forming apparatus. Various properties of the ablation laser may be optimised including: pulse rate; wavelength; power; beam shaping and/or pattern. The energy imparted to a cell to cause immotility in the cell is described as the ablation threshold and is the minimum amount of energy per unit area required to cause permanent material modification, damage or removal. For example, the ablation threshold may correspond with ablating the cell causing the cell surface membrane to rupture or otherwise damaging the cell sufficient to rapidly induce permanent immotility.

Alternatively a lower energy sorting beam may be used to ablate a cell which does not cause rapid permanent immotility but which is commensurate with the cell becoming immotile following a freezing and thawing process—this method of ablation is referred to as “priming” the unwanted cell. It requires the cell to be subjected to electromagnetic radiation sufficient to transfer energy to a selected cell below a predetermined ablation threshold commensurate with rupturing the cell membrane and above a predetermined priming threshold commensurate with the cell being unviable following a freezing and thawing process. An advantage with this approach is that debris from the unwanted cell is not released into the stream which may negatively impact on the remaining wanted cells. A further advantage with an approach which involves not rupturing the cell membrane is that any downstream genetic analysis of cells can be achieved more effectively because the media has less free DNA within it from ruptured cells.

FIG. 2 illustrates part of another system 200 for classifying and sorting cells which comprises an flow control apparatus 210 which issues a microfluidic stream 215 from an aperture 213 towards a collector 260. The system 200 also comprises an interrogation beam generator 220 such as an IR or UV illuminator, one or more detectors 230 and a sorting laser 240.

The system 200 also optionally comprises a droplet detector 265 which detects whether the microfluidic stream 215 breaks down into droplets 217 above a threshold height—the breakoff distance. This may be used as a control input for operating the system 200, for example to increase the flow rate of the particle flow and/or sheath flow if droplets are detected above the breakoff distance.

The system 200 also optionally comprises a sheath 270 which extends at least part way between the flow control apparatus 210 and the collector 260, extending in this example to the sort laser 240. The sheath may fully enclose the stream 215 to this point, or may present one or more baffles with air gaps in between.

The flow control apparatus 210 comprises a focussing chamber 211 where particle and sheath flows converge such that the sheath flow moves coaxially about the inner particle flow. This focussing has the effect of orienting asymmetric cells in the particle flow and of confining the cells within a narrow range of lateral dimensions. The focussing chamber is fluidically coupled with and tapers towards a microfluidic channel 212 which terminates in an aperture 213 in the flow control apparatus 210. The dimensions of the channel 212 may be determined experimentally to establish a stable laminar flow at the aperture 213. In particular examples, the channel 212 comprises a length of at least 10 microns to 10 mm from an exit of a flow focussing chamber to the aperture exit, wherein the aperture exit is defined as a plane perpendicular to the longitudinal or z-axis of flow aligned with the terminal end of the flow focusing apparatus. In one example the channel comprises 50 microns to 1 mm where this length allows laminar flow to re-establish following orientation ad confinement of particles in a hydrodynamic orientation and confinement focussing chamber. The channel enables a steady flow of the microfluidic stream when ejected into a gaseous environment.

The aperture 213 may have a cross-section extending in one axis or dimension (long axis) more than in a perpendicular axis or dimension (short axis). In a rectangular shaped aperture, this results in a non-unified aspect ratio, that is where the proportion of the length in one direction to the length in the other direction is greater or less than one—this may be termed an unequal aspect ratio. In particular examples, the aspect ratio lengths comprise at least 10 microns to 1 mm for example aspect ratio: 1:100 to 2:3; or 1:50 to 1:10.

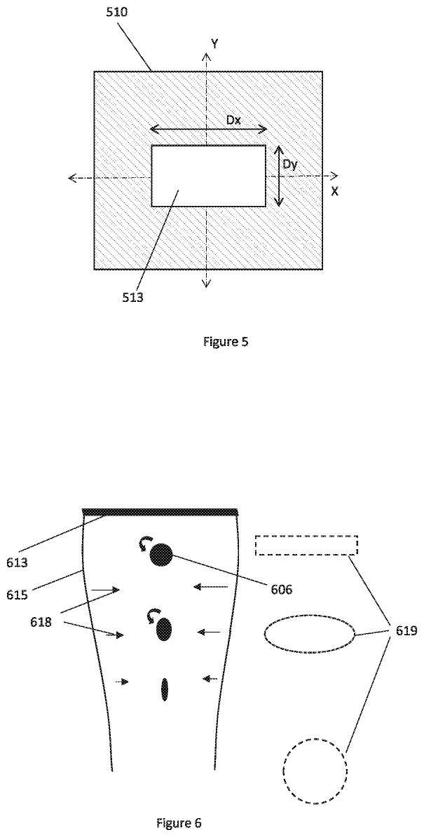

The microfluidic stream 215 is ejected from the aperture with a cross-sectional shape corresponding to that of the aperture. Where the stream is ejected into free space and not into a solid conduit such as a microfluidic channel, surface tension forces act on the liquid to make the cross-sectional shape symmetrical, tending to circular. This effect may occur over the distance 216, after which the stream assumes a stable circular cross-sectional shape. This changing cross-sectional shape results in internal hydrodynamic forces within the stream which contract along the longer axis causing further orientation of the cells not already aligned along the short axis. This is visualised in FIG. 6, which is described in more detail below. The asymmetric dimensions of the aperture 213 along the two cross-section axes therefore further improves the orientation of asymmetric cells. Various shapes may be used such as rectangular or ellipsoid.

The aperture 213 may additionally or alternatively be adjustable such that the shape, size, orientation or dimensions of the aperture cross-section may be controlled. In one example, the invention provides a system comprising an adjustable aperture in which at least one of the size, shape or aspect ratio is adapted for adjustment. This may be achieved for example by stretching a pliable material having a slit forming the aperture. The aperture may be adjusted to control various properties of the microfluidic stream 215 such as the flow rate of one or both of the particle and sheath flows, the relative proportions of the particle and sheath flows, the height at which droplets form, the orientation of the particles, or the confinement of the particles.

The aperture 213 may be adjusted into a cleaning mode in which the aperture assumes a maximum size and during which a high flow rate of sheath flow (with or without particle flow) is applied causing any particles or other debris stuck about the aperture or other parts of the flow control apparatus 210 to be dislodged and washed away.

The flow control apparatus 210 also comprises a pressure sensor 267 associated with the focussing chamber, sheath flow or particle flow. Pressure measurements may be used to control various properties of the stream such as the flow rate, the concentration of wanted cells, the height of droplet formation.

FIGS. 3 and 4 illustrate longitudinal section and transverse cross-section views respectively of a flow control apparatus 300 according to an example. The transverse cross-section of FIG. 4 is through section line AA in the longitudinal cross-section of FIG. 3. The flow control apparatus 300 comprises a delivery tube 330 fitting within a housing 305. In particular the delivery tube 330 is securely and accurately received within a cavity 310 of the housing 305, the cavity defined by internal surfaces of the housing. The delivery tube 330 comprises a lumen 340 for carrying a particle flow 345 which is a moving liquid such as an aqueous solution containing particles such as sperm cells. The lumen 340 is open at an input end of the delivery tube 330 to a delivery tube inlet 332 and is open at a distal end of the delivery tube to a delivery tube outlet 333.

The delivery tube 330 also comprises ridges, fins, or projections 335 which extend longitudinally along the delivery tube. The ridges 335 engage with the internal surface of the cavity 310 of the housing 305 in order to secure the delivery tube within the housing. In an alternative example the housing 305 comprises ridges, fins or projections which extend longitudinally along the housing and also engage with the external surface of the delivery tube. The ridges 335 may be dimensioned to ensure a friction fit with the featureless walls of the cavity 310 or the walls of the cavity may comprise corresponding grooves into which the ridges locate. Various other mechanical fixing mechanisms may alternatively be used. By extending longitudinally, the ridges 335 improve the lateral positioning of the distal end of the delivery tube 330 so that the delivery tube outlet 333 is securely and accurately located within the housing 305.

Various alternative engagement structures are possible. Whilst the ridges 335 are longitudinally extending, they may also be angled with respect to the longitudinal axis to form a spiral shape along the outside of the delivery tube. Furthermore, whilst the ridges have been shown as continuous, they may be discontinuous with parts engaging with the cavity walls at different longitudinal locations. In a further alternative arrangement, longitudinally extending ridges may extend from the cavity to engage with the delivery tube. In this alternative, the delivery tube 330 may or may not also have ridges 335 extending to the cavity wall. In a yet further alternative, the outer circumference of the delivery tube 330 may be dimensioned to mate directly with the inner wall of the cavity to ensure a friction fit. The outer surface of the delivery tube and/or the inner surface of the cavity 310 may include recesses to form channels between the housing 305 and delivery tube 330.

In the example of FIGS. 3 and 4, one or more sheath flow channels 360 are formed between the delivery tube 330 and housing 305 to carry a sheath flow 365 such as an aqueous solution. The sheath flow channel(s) 360 may extend from a sheath flow inlet 362 at the input end of the delivery tube and which includes the channels formed between the ridges 335. The sheath flow channel(s) extends along the outside of the delivery tube 330 to a focussing chamber 370 defined by a volume formed within the housing 305 at the end of the delivery tube 330 and into which the particle flow 345 is discharged from the delivery tube outlet 333. The focussing chamber 370 is also fluidly coupled to a delivery microchannel 375 having an aperture 313 from which a combined particle and sheath flow is output for downstream processing, also referred to herein as a microfluidic stream 115.

A central particle flow 345 is surrounded by one or flow sheath flows 365 in a coaxial arrangement. The shape and size of the focussing chamber 370, the geometry and dimensions of the sheath flow channel(s) 360 and the lumen 340, together with the flow rates of the particle flow 345 and sheath flow 365 all contribute to the control of the combined fluid flows from the particle delivery outlet 375. Examples use cases include controlling orientation and confinement of particles within the combined particle and fluid flow 360. In some examples, the particle flow and the sheath flow may be arranged concentrically. In other examples the central axis of the particle flow may be offset compared with the central axis of the sheath flow. This may be useful in examples where downstream interrogation and/or sorting beams have a focus offset from the previously described microfluidic stream 115; as described with respect to FIGS. 1, 12a, 12b, 13a and 13b.

As noted above, the longitudinally extending ridges or other engagement structure ensures accurate and stable lateral positioning of the delivery tube outlet 333 within the focussing chamber 370. In more conventional arrangements, a delivery needle is introduced into a tapering volume of sheath fluid however the distal end of the needle is buffeted by the fluid flows and moves laterally causing the resulting particle flow to move within the surrounding sheath fluid flow or even to partially mix with the sheath fluid flow resulting in poorly oriented and poorly confined particle fluid flows. This may make downstream processing difficult, inaccurate and inefficient.

In some examples, accurate longitudinal positioning of the delivery tube outlet 333 within the focussing chamber 370 may also help to optimise the control and stability of orientation and/or confinement of particles or other flow properties of the microfluidic stream 360 delivered from the delivery microchannel or aperture 375. In the example of FIGS. 3 and 4, this is achieved by dimensioning the ridges 335 of the delivery tube 330 to complement the dimensions of the cavity 310 of the housing 305 to prevent the delivery tube 330 from being inserted into the cavity beyond a predetermined longitudinal position.

The cavity 310 can be divided into several portions including a first portion 310-S1 which has a longitudinal cross-sectional shape, such as rectangular, which is arranged to engage at multiple longitudinal locations with a corresponding first portion of the delivery tube 330-S1. The first portion of the cavity may be substantially uniform transverse cross section along the longitudinal direction, for example of circular shape having a fixed diameter. In other examples, the cross-sectional shape may be asymmetric to encourage some asymmetry of the particle stream within the sheath stream. For example the cross-sectional shape may be oval, hemispherical, triangular or may be a combination of a smaller rectangle and a larger rectangle. This first portion S1 of the cavity 310 is used to receive the ridges 335 of the delivery tube 330. A second portion of the cavity 310-S2 tapers, having reducing dimensions when extending towards the distal end of the delivery tube. The ends of the ridges 335, having larger dimensions, prevent the delivery tube extending beyond this point, thereby ensuring accurate and stable longitudinal positioning of the delivery tube outlet 333 within the focussing chamber 370. The ends of the ridges may be shaped as shown to complement the internal shape of the cavity 310 to further improve this positioning. In other arrangements, grooves in the wall of the cavity 310 may be used to receive the ridges 335 and the length of the grooves controlled to control the longitudinal position of the delivery tube outlet 333 within the focussing chamber 370. By contrast, in more conventional arrangements a delivery needle may be placed into a tapering volume of sheath fluid however if the distal end of the needle is not correctly positioned the sheath flows may turbulently interact with the particle flow causing unwanted mixing, chaotic misalignment of the particle flow and poor particle orientation and confinement.

The tapering second portion 310-S2 of the cavity 310 may comprise a tapering angle α to the longitudinal axis, and the tapering second portion 330-S2 of the delivery tube 330 may comprise a tapering angle β to the longitudinal axis. The tapering angle can be modulated to achieve control of the acceleration of the sheath flow in portions of the sheath flow channels. The third portion 310-S3 of the cavity may comprise uniform dimensions extending over a longitudinal length. Similarly, the third portion 330-S3 of the delivery tube 330 may comprise uniform, although smaller, dimensions extending over a similar longitudinal length. The portion of the sheath channel 360 formed between these two portions 310-S3, 330-S3 does not accelerate the sheath flow 365 and allows it to stabilise to ensure laminar flow and reduce turbulence.

A fourth portion 330-S4 of the delivery tube includes a distal tip containing the delivery tube outlet 333. The tip may be shaped to enhance orientation and/or confinement of particles as described in more detail below. This tip area may be complemented by a further tapering fourth portion 310-S4 of the cavity 310. The focussing chamber 370 is formed in a fifth portion 310-S5 of the cavity 310 when the delivery tube outlet 333 is positioned to discharge the particle flow 345 into the sheath flow 365 entering the focussing chamber 370. The focussing chamber and other components of the flow control apparatus 300 are configured to cause a combined laminar flow of the particle and sheath flows out of the particle delivery outlet 375, in which the particles are largely oriented in one axis and largely confined to a plane containing that axis.

Additional portions of the delivery tube and/or sheath flow channel 360 may be included, or some described portions may be removed from some examples, such as the third portion 330-S3 from delivery tube as needed to impart targeted characteristics, such as but not limited to confinement, to the particle flow. Different geometries of the sheath flow channel to those illustrated may alternatively be employed.

In some examples, the geometries of the portions may vary along the delivery tube and/or cavity to encourage some asymmetry of the particle flow within the sheath flow of the eventual microfluidic stream.

The sheath flow 365 through the sheath flow channel 360 may be symmetric or asymmetric. For example, a larger volume in the upper half of the sheath flow channel 360 may cause the particle flow 345 to be displaced downwards. The sheath flow may also be caused to rotate about the delivery tube to generate a vortex flow which may assist with particle flow confinement. The different cross-sectional volumes of the sheath flow channel 360 along its length enables fine control of the sheath flow, including acceleration and stabilisation of the flows. The volumes of the sheath flow channels 360 also control the flow rates of the sheath flow through the channel. The ridges 335 and the channels formed between them may also act to stabilise the sheath flow as this may be introduced as a turbulent flow from outside the flow control apparatus.

FIG. 4 shows a cross-section through section line AA of FIG. 3, where the input area of the housing 305 and delivery tube 330 can be seen. This shows four evenly spaced ridges 335 extending from the delivery tube 330, although any number of ridges could alternatively be used. Various other parts of the delivery tube and housing are illustrated with the same reference numerals as used for those part in FIG. 3. One of the ridges 335L is longer than the others and corresponds with a groove 315 in the outer wall of the cavity 310 of the housing. This arrangement ensures that the delivery tube can only be received into the housing in a single orientation illustrated generally by R. In examples having multiple grooves in the cavity wall 310 each for receiving a single ridge 335, the groove 315 for the longer ridge 335L is deeper such that the longer ridge 335L will still only fit within that one groove in order to ensure a predetermined rotational alignment of the delivery tube 330 within the housing 305. In an alternative arrangement using grooves for all ridges, one of these grooves may be wider than the others to receive a wider, though not necessarily longer, ridge. In a further alternative, a pin and corresponding hole arrangement may be used to correctly index the delivery tube within the housing. For example, the pin may extend through the housing into a ridge of the delivery tube, or the delivery tube or a ridge may include a pin which extends through a hole in the housing. In another arrangement, a magnet in one of the delivery tube or housing may be used with another magnet (or metallic feature) within the corresponding housing or delivery tube. Various other mechanical rotational alignment features may alternatively or additionally be used.

The externally visual surfaces of the housing and delivery tube may be marked to assist a user to align the delivery tube when inserting this into the housing to ensure rotational alignment.

In some examples, the sheath flow channels 360 and/or the lateral position of the delivery tube outlet 333 may be asymmetrical to generate a particle flow which is offset within the surrounding sheath flow of the microfluidic stream issued from the aperture 313.

Some examples may utilise a different configuration for the flow control apparatus 300 used to provide the microfluidic stream.

FIG. 5 illustrates a cross-sectional view of an aperture 513 according to one example in an flow control apparatus 510 and from which a microfluidic stream having the combined particle and sheath flows exits. The aperture is rectangular and has a length Dx in one (long) axis X which is longer than a length Dy in a perpendicular (short) axis Y. This provides an aperture with an unequal aspect ratio. Referring also to FIG. 6, the shape of the stream 615 can be seen as it exits the aperture 613 where it has a cross-sectional shape which is the same as the aperture—in this case rectangular as illustrated in dashed outline on the right. Asymmetric cells 606 having a flattened circular shape are also shown within the stream 615. Once the stream 615 leaves the aperture 613, surface tension acts on the surface of the stream to cause its cross-section to converse to a circular shape. This change in shape causes hydrodynamic forces 618 within the stream along the longest dimension Dx as this dimension shortens. These forces 618 act to orient the cells 606 along what was the shortest dimension Dy. These surface tension effects can synergise with the effects of a focussing chamber 211, 370 to improve alignment of the cells which in turn improves interrogation and hence classification of the cells.

FIG. 6 illustrates how surface tension forces act on the microfluidic stream 615 issuing from an aperture 613 having an asymmetric or non-circular cross-sectional area to cause this to assume a circular cross-sectional shape where the surface tension is evenly distributed. This action causes hydrodynamic forces 618 within the microfluidic stream to orient asymmetric particles 606 in a preferred direction for interacting with interrogation and/or sorting beams. The change in cross-sectional shape is illustrated at 619 and the changing orientation of the particles 606 with this changing shape is also illustrated.

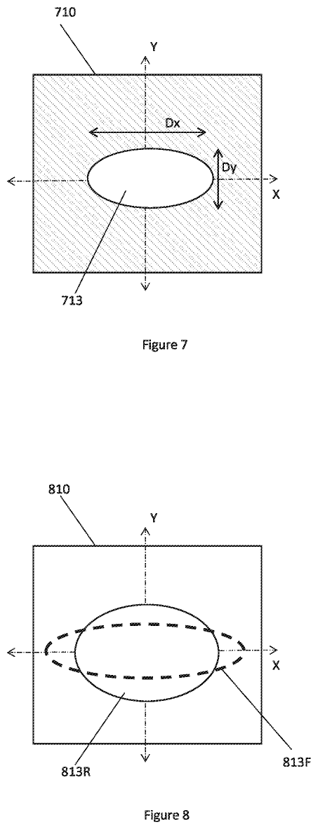

FIG. 7 illustrates a cross-sectional view of an aperture 713 according to another example in an inlet arrangement 710 and from which a microfluidic stream having the combined particle and sheath flows exits. The aperture 713 has an ellipse shape with a length Dx in one axis X which is longer than a length Dy in a perpendicular axis Y. This provides an aperture with an unequal aspect ratio. As with the example of FIG. 5, the longer extension in one direction (X) compared with extension in a perpendicular direction (Y) causes surface tension effects to change the cross-sectional shape of the stream when it enters the flow environment below the aperture, from the cross-sectional shape of the aperture 713 to a circular shape. This in turn generates hydrodynamic forces which help to orient the cells in a wanted axis.

Whilst rectangular and ellipse shapes have been described other shapes having a longer dimension in one axis compared to the perpendicular axis may alternatively be used. Examples include: parallelogram; trapezoid; polygon. Single axis asymmetrical shapes may also be used, such as a semi-circle or a triangle, or the shape may be completely asymmetric along both perpendicular axes.

The aperture 713 emits the microfluidic stream into the flow environment, and confinement chambers if used, for downstream processing. In some examples the width Dx (X-axis) of at least one of the delivery microchannel 375 leading to the aperture, or the aperture itself, is 10 μm to 200 μm. Preferably the width Dx is between 50 μm and 150 μm. In some examples the width is equal to the depth Dy (Y-axis).

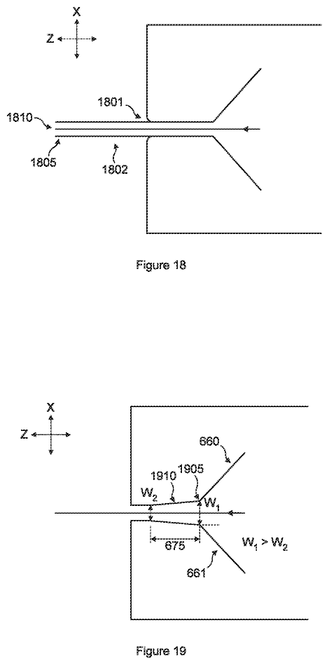

In one example shown in FIG. 18 and applicable to any of the flow control apparatus or methods described herein, the delivery microchannel 1801 immediately adjacent the aperture comprises a an expanding longitudinal taper from a smaller delivery microchannel cross-sectional area upstream to a larger delivery microchannel cross-sectional area downstream, for example at the aperture itself, where the cross-sectional area is defined perpendicular to the axis of flow. The expanding longitudinal taper may be confined to a short length of the microchannel adjacent the aperture, with the rest of the microchannel having a constant cross-sectional area. For example, the short length may be between 1-10% of the full length of the microchannel. In example the expanding longitudinal taper may be a trumpet shaped delivery microchannel to aperture transition. This trumpet-shaped delivery microchannel-to-aperture transition has been found to produce a more stable microfluidic stream 1802 within the downstream flow environment. The sample flow 1810 is surrounded by the sheath flow 1805 and using the trumpet-shaped flared aperture design provides enhanced confinement, interrogation and sorting downstream.

In some examples, the length of the delivery microchannel 1801 (Z-axis) is at least 10 microns to 10 mm from an exit of a downstream confinement chamber to the aperture 313. In this case, the aperture is defined as a point on a plane perpendicular to the z-axis of flow aligned with the terminal end of the flow focusing apparatus. In one example the channel length 375 is in the range of 50 microns to 1 mm. This length may facilitate fully developed laminar flow to re-establish following orientation and confinement of particles in orientation and confinement chambers upstream.

In one example shown in FIG. 19, the width is reduced at a downstream point in the delivery microchannel compared to a width at an upstream point in the microchannel. For example the width W₂ compared to the width W₁ upstream at the entry point 1905 of the delivery microchannel 1910. This reduction in width from W₁ to W₂ shown has the beneficial effect of further increasing confinement of the particles. The reduction in width may be a taper along a portion of the length of the delivery microchannel as shown in FIG. 19, or along the entirety of it. In one example, W₂ is between 50% to 95% of W₁. In particular examples, the width reduces from between 100-150 μm to 50-99 μm. In one particular example, the width reduces from approximately 125 μm to approximately 50 μm.

The reducing longitudinal taper of the microchannel shown in FIG. 19 may be combined with the expanding longitudinal taper shown in FIG. 18.

The cross-sectional shape of the delivery microchannel 375, its inlet and outlet or aperture 313 may be the same or different, and may include: circular, elliptical, triangular, square or rectangular of various aspect ratios. In one example, the delivery microchannel 375, its inlet and aperture 313 comprise the same rectangular cross-section with an aspect ratio of greater than 1:1.

In a further example, the aperture cross-sectional shape comprises a square or a rectangle. Without wishing to be bound by theory, the cross-sectional shape with right angle corners is understood to provide benefits in terms of providing a substantially flat surface for the interrogation beam to enter the microfluidic stream, and any light emissions to exit from the stream. In one example, the stream is emitted into a rectangular microfluidic channel and in this instance the shape of the exit aperture and the channel are substantially aligned. This ensures a smooth transition without turbulent flow. In another example, the microfluidic stream is emitted into a gaseous free space fluid flow environment. In this instance, the shape of the stream will immediately be induced to a circular cross-section by surface tension re-shaping effects. Provided interrogation occurs early enough following stream ejection, the substantially flat surface post-ejection will still be presented to the interrogation beam and the advantage of the aperture shape can still be exploited to improve interrogation and detection of cell emissions. Accordingly, in one example, the emanation distance is less than 250 μm. In a further example, the emanation distance is less than 200 μm. The flow speed also determines the distance beyond which the flow re-forms into a substantially circular cross-section. According, in one example the flow speed is greater than 5 m/s. In other embodiments, the flow speed is from 5 m/s to 20 m/s. The inventors have found that if a flow speed below 5 m/s is used in a gaseous fluid environment, the stream breaks up, and oscillations appear in the flow which detrimentally affect interrogation and sorting efficiency.

FIG. 8 illustrates a cross-sectional view of an adjustable aperture 813R, 813F according to another example in an flow control apparatus 810 and from which a microfluidic stream having the combined particle and sheath flows exits. The aperture may have a circular or slightly elliptical cross-sectional shape in a rest state 813R and an elliptical with a greater proportion of length in one axis X compared with a perpendicular axis Y in a forced state 813F. This may be achieved using a pliable plastics membrane which is stretched in the X axis to achieve the aperture shape with a more unequal aspect ratio. In one example, size-tuneable membranes nanopores or micropores may be used-see for example Roberts, G. S., Kozak, D., Anderson, W., Broom, M. F., Vogel, R., & Trau, M. (2010). Tunable Nano/Micropores for Particle Detection and Discrimination: Scanning Ion Occlusion Spectroscopy. Small, 6 (23), 2653-2658. Doi: 10.1002/smll.201001129.

In different arrangements the cross-sectional shape may remain substantially the same between rest and forced states, with the aperture only changing in size or cross-sectional area. Different combinations of cross-sectional shape may be employed, for example: circular, elliptical, rectangular, triangular, parallelogram and any others.

The adjustable aperture may be used to accommodate different batches of cells which may use different aqueous solutions or have other properties which could affect factors such as orientation efficiency, the speed at which cells can be interrogated and/or sorted as well as stream properties which may impact wanted cell concentration and other features. Aperture size and/or shape may be controlled in concert with other controllable and/or measurable properties such as flow rates and breakoff distance in order to achieve desired operational states of a classification and sorting apparatus.

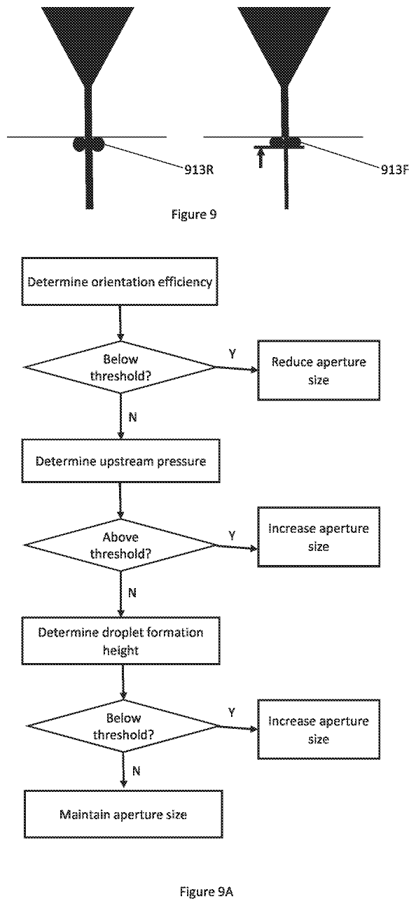

FIG. 9 illustrates a side view of an adjustable aperture arrangement which comprises an O-ring 913R, 913F which in a rest state 913R forms a circular or elliptical shaped aperture. For perspective a focussing chamber and channel as well as a stream below the aperture 913R are also shown. A force may be applied upwards on the O-ring to deform the aperture 913F into a force state. The forced state aperture 913R may retain the same cross-sectional shape but having a smaller diameter.

Examples may comprise illuminators, detectors and sorting apparatus which each comprise multiple optical components. Where separation of the components from the microfluidic stream is required, for example where a channel or conduit is used, or where a sheath is used to cover said components, the optical architecture may comprise one or more optically transparent windows to enable the optical radiation to pass through to focus radiation energy on the particle which may achieve at least one of: a torque and/or a pressure on the particle; vaporization of some of the microfluidic stream, for example for sorting and/or concentration of particles and/or droplet formation; interrogation of particles by encouraging fluorescent emissions for example. Potential materials include: Si, Ge, ZnSe, certain polymers. Si, ZnSe (or similar), polymers may be compatible with visible, NIR, or SWIR (500-1600 nm) optical interrogation or manipulation, if desired. ZnSe or similar may be used to permit visible light viewing, interrogation and possible manipulation (orienting torque, pressure to change direction, or laser-based cell damage or ablation). Another feature may be antireflection coatings applied to both sides of each window, such as AR coatings designed for air externally, water internally. Another feature may be tilting, or wedge-shaped windows to further reduce effects of reflections. Another feature may be a channel or fluid stream width that exceeds the spot size of the laser (e.g. the QCL) so small shifts in the channel or fluid stream position with respect to the beam do not create false signals.

In a microfluidic stream ejected into a gaseous environment, emission from particles may be affected by differences in the refractive index between the liquid stream and the gaseous environment. As such, for optimal detection of emissions, the one or more detectors may be positioned to take account of this refractive effect on the emissions. In one example the one or more detectors are positioned to collect the maximum emission from the particle. In one example, two detectors are used and the angle between the detectors is greater than 90° and less than 120°. In another example, two detectors are used and the angle between the detectors is less than 90° and less than 120°.

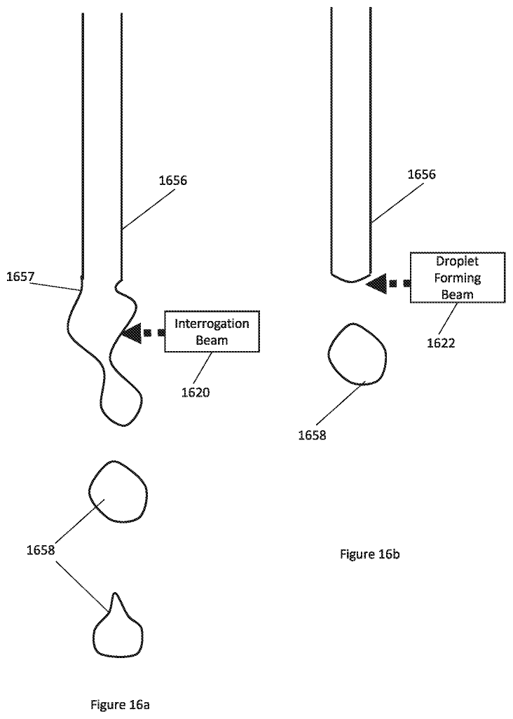

Detector positioning may also be affected by destabilisation of the microfluidic stream prior to droplet formation. This phenomenon is illustrated in FIG. 16a where a stable or laminar flowing part 1656 of the microfluidic stream forms an unstable region 1657 prior to separation of the fluid into droplets 1658. In the unstable region 1657, the radius of the microfluidic stream fluctuates leading to changing angles of incidence of incoming beams, such as an interrogation beam 1620 as illustrated. This may lead to the focal point changing and indeed hydrodynamic forces within this region may cause turbulent flow and change the path of particles entrained therein. This in turn may lead to inaccurate interrogation and classification of particles or where a sorting beam is involved inaccurate targeting of an unwanted particle. Positioning of incoming beams may therefore need to be located well above this unstable region 1657 to avoid its influence as the point at which these effects start may varying.

In some examples, the length of the delivery microchannel 375 (longitudinal or Z-axis of flow) is at least 10 microns to 10 mm from an exit of a focussing chamber 370 to the aperture 313, wherein the aperture is defined as a point on a plane perpendicular to the z-axis of flow aligned with the terminal end of the flow focusing apparatus. In one example the delivery microchannel comprises 50 microns to 1 mm where this length allows laminar flow to re-establish following orientation and confinement of particles in the orientation and confinement chambers upstream. The inventors have found that a minimum length of 10 microns is required to ensure that the flowing fluid has chance to stabilise and assume a laminar flow profile prior to emanating from the aperture.

In another example show in FIG. 16b, droplet formation may be encouraged before the development of an unstable region by applying a droplet forming or vaporising beam 1622 at a stable part 1656 of the microfluid stream. Greater control over droplet formation may enable more confident location of detectors and beam forming devices and may also shorten the distance over which the system operates. For example, where a vaporising sorting beam is employed, this may be implemented closer to the interrogation beam by encouraging early development of droplets using a droplet forming beam 1622.

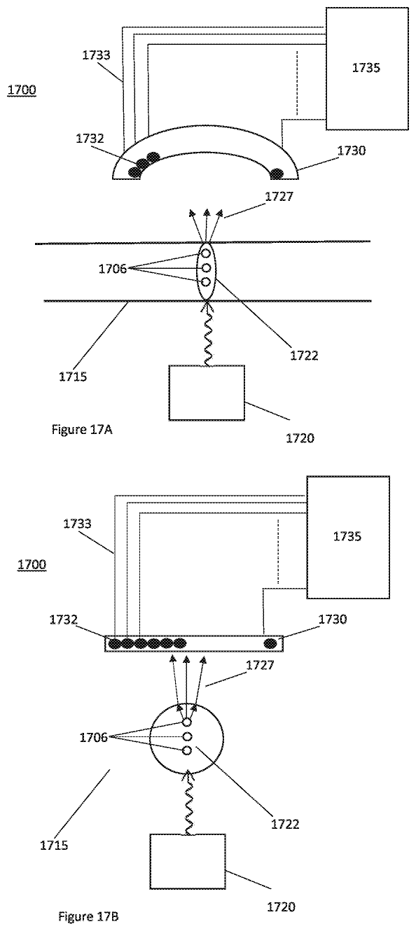

In another example illustrated in FIG. 17, a detection apparatus 1700 comprises one or more illuminators 1720 arranged to direct a beam into a microfluidic stream 1715 and a detector 1730 arranged to detect responsive emissions from a particle 1706 impacted by the beam. One or more interrogation beams may be used with a plurality of detectors arranged in an arc to collect responsive emissions from particles in a microfluidic stream. In other examples, the plurality of detectors may be arranged linearly as shown in FIG. 17B. In an example the beam 1722 may be an infrared or UV beam and the emanations 1727 may be fluorescent light. The beam 1722 may be controlled to provide an elliptical intensity pattern across the microfluidic stream 1715, however other intensity patterns may be generated such as circular.

Whilst ideally particles 1706 may be intended to be well confined within a narrow cross-sectional portion of the microfluidic stream, in practice the particles may spread out across a greater cross-sectional portion of the microfluidic stream as illustrated with particles 1706 at three representative positions. Particles at different lateral positions within the stream may result in different emanations 1727 towards the detector 1730. For example, fluorescent light 1727 may be transmitted in different directions and/or propagate different distances through the microfluidic stream. The different directions may also result in different diffraction angles through the interface between the microfluidic stream 1715 and the flow environment between it and the detector.

In an example the detector 1730 may comprise a plurality of detection units 1732 such as photodiodes in a photoarray that are arranged over a range of angles from the point at which the interrogation beam 1722 intersects particles 1706. This range of angles may extend in more than one plane. For example, the photoarray may be arranged to capture emanations from particles in different positions 1706 within the interrogation beam 1722.

The output 1733 from each detection unit 1732 is sent to an analyser 1735 which is arranged to integrate the outputs from the detection units into a signal that can be used to classify the particle. Different weightings may be applied to some outputs, for example outputs at the edges of the detector 1730 may correspond to emissions that have been more degraded than others in which case they may be amplified to normalise the amplitude of the outputs 1733. There may also be different delays and phases between different emissions 1727 due to different propagation paths and the analyser 1735 may be configured to compensate for these or otherwise normalise the signals. In one example the circular cross-section of the microfluidic stream causes refraction of the fluorescent emissions during the transition from a medium from a first refractive index to a second refractive index. In this example, the independent detection of emission signals at different positions on the array (which may be linear, an arc or other shapes) enables the analyser to independently scale at least one of the independently detected emissions to result in a normalised signal which accounts for the effect of the refraction. This results in enhanced signal processing characteristics and higher accuracy in determining cell characteristics and downstream sorting. The detector may be used with a collection objective.

In some examples, the differences in propagation paths and/or refractive properties may be used by the analyser 1735 to improve classification of the particle despite different possible refractive properties of the stream or positions of particles within the beam 1722. The correspondence between outputs 1733 and particle classification may be determined experimentally or using machine learning for example.

Any and all references to publications or other documents, including but not limited to, patents, patent applications, articles, webpages, books, etc., presented anywhere in the present application, are herein incorporated by reference in their entirety.

As noted elsewhere, the disclosed examples have been described for illustrative purposes only and are not limiting. Other examples are possible and are covered by the disclosure, which will be apparent from the teachings contained herein. Thus, the breadth and scope of the disclosure should not be limited by any of the above-described examples but should be defined only in accordance with claims supported by the present disclosure and their equivalents. Moreover, examples of the subject disclosure may include methods, systems and apparatuses/devices which may further include any and all elements from any other disclosed methods, systems, and devices, including any and all elements corresponding to binding event determinative systems, devices and methods. In other words, elements from one or another disclosed examples may be interchangeable with elements from other disclosed examples. In addition, one or more features/elements of disclosed examples may be removed and still result in patentable subject matter (and thus, resulting in yet more examples of the subject disclosure). Also, some examples correspond to systems, devices and methods which specifically lack one and/or another element, structure, and/or steps (as applicable), as compared to teachings of the prior art, and therefore, represent patentable subject matter and are distinguishable therefrom (i.e., claims directed to such examples may contain one or more negative limitations to note the lack of one or more features prior art teachings).

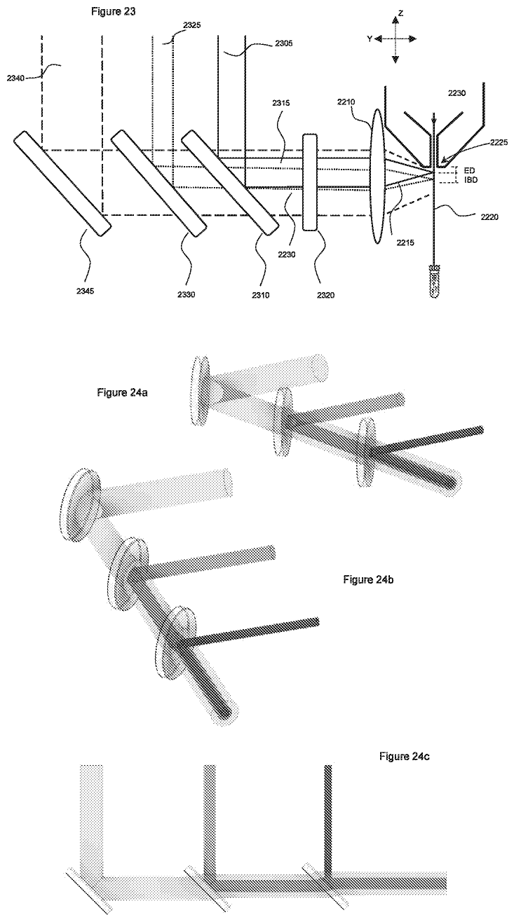

It will be appreciated that whilst for convenience and simplicity of explanation, different features have been described separately, these features may be combined in different ways in different examples. For example, features of the flow control apparatus such as those shown in FIGS. 18, 19, 20a, 3, 4, 5, 7, 8, 9. Similarly, different aspects of the downstream processing may be combined such as those shown in FIGS. 1, 2, 11a-12b, 14, 17a, 17b, 20a, 20b, 22a-22c, 23, 24a-24c.

Various inventive concepts disclosed herein may be embodied as one or more methods (as so noted). The acts performed as part of the method may be ordered in any suitable way. Accordingly, examples may be constructed in which acts are performed in an order different than illustrated, which may include performing some acts simultaneously, even though shown as sequential acts in illustrative examples.

### REFERENCES

1. Cossarizza A, Chang H D, Radbruch A, et al. Guidelines for the use of flow cytometry and cell sorting in immunological studies. Eur J Immunol. 2017; 47 (10): 1584-1797. doi: 10.1002/eji.201646632

1. A method of processing particles in a particle flow, the method comprising:
delivering a microfluidic stream from a microfluidic aperture into a flow environment, the microfluidic stream comprising a particle flow comprising a plurality of particles;
directing interrogating electromagnetic radiation at the particles in the microfluidic steam and monitoring responsive emissions from the irradiated particles;
subsequently directing sorting electromagnetic radiation at least some of the particles in the microfluidic stream in order to sort the particles into at least two populations dependent on the monitored responsive emissions of the particles; and
the microfluidic stream comprising a continuous phase flow of liquid.

2. The method of claim 1, wherein the flow environment comprises one or more of the following:
a microchannel which optionally comprises a substantially transparent material;
a substrate exposed to a fluid environment;
a liquid fluid environment; and
a gaseous fluid environment.

3. The method of claim 2, wherein the flow environment comprises a gaseous fluid environment and is at least partially enclosed by a gaseous sheath substantially parallel to the microfluidic stream and moving with respect to the gaseous environment.

4. The method of claim 1, wherein the sorting comprises one or more of the following:
a) directing the subsequent sorting electromagnetic radiation at particles in one of the populations in the microfluidic stream to impart radiation pressure on said particles;
b) directing the sorting subsequent electromagnetic radiation at particles in one of the populations in the microfluidic stream to ablate said particles;
c) directing the sorting subsequent electromagnetic radiation at particles which are biological cells wherein the subsequent sorting electromagnetic radiation is configured to transfer energy to a selected cell below a predetermined ablation threshold commensurate with rupturing the cell membrane and above a predetermined priming threshold commensurate with the cell being unviable following a freezing and thawing process.

5. The method of claim 1, wherein the interrogating electromagnetic radiation and the sorting electromagnetic radiation are directed through a common optical objective.

6. The method of claim 5, wherein the interrogating electromagnetic radiation and the sorting electromagnetic radiation are directed through the common optical objective at an angle with respect to each other.

7. The method of claim 6, wherein the angle between the interrogating electromagnetic radiation and the sorting electromagnetic radiation directed through the common optical objective is adjusted in order to define an inter-beam distance between a focal point of the interrogating electromagnetic radiation within the microfluidic steam and a focal point of the sorting electromagnetic radiation within the microfluidic steam.

8. The method of claim 5, wherein the microfluidic stream is delivered from a flow control apparatus having the microfluidic aperture, the flow control apparatus being shaped to define a region above the microfluidic aperture through which the interrogating electromagnetic radiation and/or the sorting electromagnetic radiation are directed.

9. The method of claim 8, wherein the objective optical component is positioned at least partially within the region.

10. The method of claim 1, wherein the interrogating electromagnetic radiation propagates as an interrogating beam which intersects the microfluidic stream at an emanation distance from the microfluidic aperture, the emanation distance being between 25 and 1000 μm.

11-104. (canceled)

105. The method of claim 1, wherein the interrogating electromagnetic radiation and the subsequent sorting electromagnetic radiation propagate as respective interrogating and sorting beams which intersect the microfluidic stream separated by an inter-beam distance comprising at least 10 μm.

106. The method of claim 1, wherein monitoring responsive emissions from the irradiated particles comprises using outputs from a plurality of sensors arrayed about the microfluidic stream arranged to capture responsive emissions from different directions, wherein the output from said sensors are normalised to compensate for differences in one of more of the following properties of the responsive emissions captured from respective sensors: amplitude; phase; propagation delay; refractive effects when crossing from the microfluidic stream into the flow environment.

107. The method of claim 1, comprising adjusting the cross-section of the microfluidic aperture.

108. An apparatus for processing particles in a particle flow, the apparatus comprising:
means for delivering a microfluidic stream from a microfluidic aperture into a flow environment, the microfluidic stream comprising a particle flow comprising a plurality of particles;
means for directing interrogating electromagnetic radiation at the particles in the microfluidic steam and monitoring responsive emissions from the irradiated particles;
means for directing sorting electromagnetic radiation of at least some of the particles in the microfluidic stream in order to sort the particles into at least two populations dependent on the monitored responsive emissions of the particles;
wherein the means for delivering the microfluidic stream is configured to maintain the microfluidic stream as a continuous phase flow of liquid when receiving said electromagnetic radiation.

109. The apparatus of claim 108, comprising a common optical objective which the interrogating electromagnetic radiation and the sorting electromagnetic radiation are directed through.

110. The apparatus of claim 109, configured to direct the interrogating electromagnetic radiation and the sorting electromagnetic radiation through the common optical objective at an angle with respect to each other.

111. The apparatus of claim 110, wherein the angle between the interrogating electromagnetic radiation and the sorting electromagnetic radiation directed through the common optical objective is adjustable in order to define an inter-beam distance between a focal point of the interrogating electromagnetic radiation within the microfluidic steam and a focal point of the sorting electromagnetic radiation within the microfluidic steam.

112. The apparatus of claim 109, wherein the means for delivering a microfluidic stream comprises a flow control apparatus having the microfluidic aperture through which the microfluidic stream is delivered, the flow control apparatus being shaped to define a region above the microfluidic aperture through which the interrogating electromagnetic radiation and/or the sorting electromagnetic radiation are directed.

113. The apparatus of claim 112, wherein the objective optical component is positioned at least partially within the region.

114. The apparatus of claim 113, wherein the cross-section of the microfluidic aperture is adjustable.
